(19) United States
(12) Patent Application Publication
(10) Pub. No.: US 2022/0333042 A1
(43) Pub. Date: Oct. 20, 2022

(54) ENZYMATIC FLOOR CLEANING COMPOSITION

(71) Applicant: ECOLAB USA INC., Saint Paul, MN (US)

(72) Inventors: Derrick Anderson, Saint Paul, MN (US); Erik C. Olson, Saint Paul, MN (US); Wendy Lo, Saint Paul, MN (US); Melissa Martinez-Crowley, Saint Paul, MN (US)

(21) Appl. No.: 17/659,399

(22) Filed: Apr. 15, 2022

Related U.S. Application Data
(60) Provisional application No. 63/201,162, filed on Apr. 15, 2021.

(51) Int. Cl. C11D 3/386; C11D 1/12; C11D 1/72

(52) U.S. Cl. CPC C11D 3/38645; C11D 3/386; C11D 3/38627; C11D 3/38636; C11D 1/12; C11D 1/72

(57) ABSTRACT

The disclosure relates to hard surface cleaning compositions, methods of making the hard surface cleaning compositions, and methods of using the hard surface cleaning compositions. The hard surface cleaning compositions are enzymatic and near neutral in pH. In particular, the hard surface cleaning compositions have reduced surface tension for cleaning surfaces with low surface free energy. Preferably, the hard surface cleaning compositions have low contact angles on a variety of surfaces. In a preferred embodiment, the hard surface cleaning compositions comprise a biocide.

### CROSS REFERENCE

This application is related to and claims priority under 35 U.S.C. § 119 to U.S. Provisional Application Ser. No. 63/201,162 filed on Apr. 15, 2021 and entitled “ENZYMATIC FLOOR CLEANING COMPOSITION”; the entire contents of this patent application are hereby expressly incorporated herein by reference.

### FIELD OF THE INVENTION

The invention relates to hard surface cleaning compositions. In particular, hard surface cleaning compositions having reduced surface tension for cleaning surfaces with low surface free energy.

### BACKGROUND OF THE INVENTION

The development of new surface materials and coatings, and in particular energy efficient materials and coatings, has resulted in greater difficulties for cleaning soils. Many surfaces are more hydrophobic and now have lower surface free energy making it more difficult to remove soils. An additional complication is that in certain contexts multiple types of surfaces and soils are encountered in a single location. For example, in restaurants the floors in the kitchen, dining area, and entry ways can differ greatly and the soils encountered in those areas can differ greatly whether the soils are tracked in by shoes, food soils, or cooking soils. Historically such distinctions in surface and soil types have necessitated different cleaning compositions for the different areas and different soils.

The use of enzymes may also greatly enhance a cleaning compositions effectiveness. However, as enzymes are proteins, their efficacy can be greatly affected by surfactants and salts. Both surfactants and salts may cause the enzyme to denature or to change conformation sufficiently that it will lose efficacy to the point it loses all efficacy.

Accordingly, it is an objective of this disclosure to develop cleaning compositions that are useful on varying surface types and useful for removing multiple types of soils.

A further object of this disclosure is the development of cleaning compositions and methods that can remove soils from surfaces having a low surface free energy which include an enzyme.

Other objects, advantages and features of this disclosure will become apparent from the following specification taken in conjunction with the accompanying figures.

### BRIEF SUMMARY OF THE INVENTION

The hard surface cleaning compositions described herein are advantageous as they have reduced surface tension and include an enzyme and/or a biocide. It is an advantage of the technology described herein that the hard surface cleaning compositions described herein are particularly suitable for cleaning multiple surface types and removing multiple soil types. Still a further advantage of the cleaning compositions described herein is that they are able to wet surfaces having a low surface free energy. Yet another advantage is that certain embodiments also provide a non-food sanitizing effect.

A preferred embodiment is an enzymatic hard surface cleaning composition comprised of a surfactant blend comprising one or more of an anionic surfactant, an amphoteric surfactant, and a nonionic surfactant, an enzyme, and water. Preferably, the composition has a pH between about 5.5 and about 10. Preferably, the anionic surfactant is sulfated, sulfonated, and/or carboxylated; the amphoteric surfactant comprises an amine oxide, a betaine, a sultaine, or a mixture thereof; and the nonionic surfactant comprises an alkyl polyglycoside, a linear or branched alkoxylate, and/or an EO/PO copolymer. The hard surface cleaning compositions can be concentrated compositions or use solutions. The concentrated hard surface compositions can be solid or liquid.

In a preferred embodiment, the enzymatic hard surface cleaning composition comprises an enzyme, a biocide, water, and a surfactant blend comprising an amphoteric surfactant and a nonionic surfactant. Preferably, the composition has a pH between about 5.5 and about 10. Preferably, the amphoteric surfactant comprises an amine oxide, a betaine, a sultaine, or a mixture thereof, and the nonionic surfactant comprises an alkyl polyglycoside, a linear or branched alkoxylate, and/or an EO/PO copolymer.

In a preferred embodiment, the enzymatic hard surface cleaning composition comprises an enzyme, water, and a surfactant blend comprising an anionic surfactant and a nonionic surfactant. Preferably, the composition has a pH between about 5.5 and about 10. Preferably, the anionic surfactant is sulfated, sulfonated, and/or carboxylated, and the nonionic surfactant comprises an alkyl polyglycoside, a linear or branched alkoxylate, and/or an EO/PO copolymer.

A preferred embodiment is a hard surface enzymatic sanitizing composition comprised of a nonionic surfactant, a biocide, an enzyme, and water. Preferably the composition has a pH of between about 6.5 and about 10.5. Preferably, the nonionic surfactant comprises an alkyl polyglycoside, a linear or branched alkoxylate, an EO/PO copolymer, or a mixture thereof. Preferably, the composition is free of an anionic surfactant. The hard surface cleaning compositions can be concentrated compositions or use solutions. The concentrated hard surface compositions can be solid or liquid.

In a preferred embodiment, the hard surface enzymatic sanitizing composition comprises a nonionic surfactant blend, a biocide, an enzyme, and water. Preferably the composition has a pH of between about 6.5 and about 10.5. Preferably, the nonionic surfactant blend comprises an alkyl polyglycoside and a linear or branched alkoxylate. Preferably, the composition is free of an anionic surfactant. Preferably the biocide comprises a di-alkyl chain quaternary ammonium compound or salt thereof having an R group from about 2 carbons to about 12 carbons, wherein the salt is a bicarbonate, carboxylate, chloride, carbonate, phosphate, sulfonate, sulfate, polycarboxylate, or a combination thereof. The hard surface cleaning compositions can be concentrated compositions or use solutions. The concentrated hard surface compositions can be solid or liquid.

The present disclosure also describes methods of preparing the hard surface cleaning compositions including methods of preparing liquid and solid compositions, concentrated compositions and use solutions.

The present disclosure also describes methods of cleaning a hard surface comprising contacting a hard surface with a hard surface cleaning composition. In a preferred embodiment, the hard surface can be rinsed after contact with the hard surface cleaning composition.

While multiple embodiments are disclosed, still other embodiments will become apparent to those skilled in the art from the following detailed description, examples, and accompanying figures, which shows and describes illustrative embodiments of the invention. Accordingly, the figures and detailed description are to be regarded as illustrative in nature and not restrictive.

### BRIEF DESCRIPTION OF THE FIGURES

FIG. 1 shows a comparison of the dynamic surface tension of various commercial cleaners.

FIG. 2 shows a comparison of the efficacy of various cleaning compositions on greasy soil removal as shown by the removal of a red soil composition and hydrocarbon and soot soil removal as shown by the removal of a black soil composition on soiled vinyl tiles when compared to water.

FIG. 3 shows stability over time of enzymes when stored for up to 8 weeks under different temperature conditions, specifically at room temperature, at 40° C., and at 50° C.

FIG. 4 shows a comparison of the efficacy of various cleaning compositions at different concentrations on hydrocarbon and soot soil removal as shown by the removal of black soil compositions.

FIG. 5A shows a comparison of the efficacy of a commercial enzymatic cleaner, a commercial alkaline cleaner, and an enzymatic cleaner of the invention for their removal of grease soil after a 20-hour soak.

FIG. 5B shows example tiles of the comparison after a 20-hour soak.

FIG. 6A shows a comparison of the efficacy of a commercial enzymatic cleaner and an enzymatic cleaner of the invention at different concentrations for their removal of grease and lightly proteinaceous soil after a 20-hour soak.

FIG. 6B shows example tiles of the comparison after a 20-hour soak.

FIG. 7A shows a comparison of the efficacy of a commercial enzymatic cleaner and an enzymatic cleaner of the invention at different concentrations for their removal of grease and moderately proteinaceous soil after a 20-hour soak.

FIG. 7B shows example tiles of the comparison after a 20-hour soak.

FIG. 8A shows the chemical residue of exemplary floor cleaner compositions at a water hardness of 0 gpg after 730 dips in the water in order to simulate the about 2 years of use.

FIG. 8B shows the chemical residue of exemplary floor cleaner compositions at a water hardness of 5 gpg after 730 dips in the water in order to simulate the about 2 years of use.

FIG. 8C shows the chemical residue of exemplary floor cleaner compositions at a water hardness of 17 gpg after 730 dips in the water in order to simulate the about 2 years of use.

FIG. 9A shows the hardwater tolerance of an exemplary floor cleaner composition with no additives after 100 dips in water having a hardness of 17 gpg at pH 8.0.

FIG. 9B shows the hardwater tolerance of an exemplary floor cleaner composition with 350 ppm of triethanolamine and 500 ppm of citrate at a water hardness of 17 gpg at pH 9.25.

FIG. 9C shows the hardwater tolerance of an exemplary floor cleaner compositions with 350 ppm of triethanolamine at a water hardness of 17 gpg at pH 9.25.

FIG. 10 is a graph of Table 7 showing the percent retained enzyme under various storage conditions and storage times.

FIG. 11A shows a photograph demonstrating the efficacy of a commercial non-enzymatic alkaline cleaner for the removal of grease after a static soak of 20 hours at a neutral pH.

FIG. 11B shows a photograph demonstrating the efficacy of an enzymatic cleaner as disclosed herein for the removal of grease after a static soak of 20 hours at a neutral pH.

FIG. 11C shows a photograph demonstrating the efficacy of a commercial enzymatic cleaner for the removal of grease after a static soak of 20 hours at a neutral pH.

FIG. 11D shows a photograph demonstrating the efficacy of a different commercial enzymatic cleaner for the removal of grease after a static soak of 20 hours at a neutral pH.

FIG. 12A shows a photograph demonstrating the efficacy of a commercial non-enzymatic alkaline cleaner for the removal of grease and protein after a static soak of 2 hours.

FIG. 12B shows a photograph demonstrating the efficacy of an enzymatic cleaner as disclosed herein for the removal of grease and protein after a static soak of 2 hours.

FIG. 12C shows a photograph demonstrating the efficacy of a commercial enzymatic cleaner for the removal of grease and protein after a static soak of 2 hours.

FIG. 12D shows a photograph demonstrating the efficacy of a different commercial enzymatic cleaner for the removal of grease and protein after a static soak of 2 hours.

FIG. 13A shows a photograph demonstrating the efficacy of a commercial non-enzymatic alkaline cleaner for the removal of grease after a 30 min soak (left sample) and protein after a 3 hour soak (right sample).

FIG. 13B shows a photograph demonstrating the efficacy of an enzymatic cleaner as disclosed herein for the removal of grease after a 30 min soak (left sample) and protein after a 3 hour soak (right sample).

FIG. 13C shows a photograph demonstrating the efficacy of a commercially available enzymatic cleaner for the removal of grease after a 30 min soak (left sample) and protein after a 3 hour soak (right sample).

Various embodiments of the present invention will be described in detail with reference to the figures. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENT

The present disclosure relates to hard surface cleaning compositions with reduced surface tension and methods of making and using the same. The hard surface cleaning compositions described herein have many advantages over existing hard surface cleaning compositions. For example, the hard surface cleaning compositions having reduced surface tension and are suitable for cleaning surfaces with low surface free energy. Further, the hard surface cleaning compositions are effective at cleaning a variety of surfaces and effective at removing a variety of soil types.

The embodiments of this invention are not limited to particular hard surfaces or soils, which can vary and are understood by skilled artisans. It is further to be understood that all terminology used herein is for the purpose of describing particular embodiments only and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

References to elements herein are intended to encompass any or all of their oxidative states and isotopes. For example discussion of aluminum can include Al^{I}, Al^{II}, or Al^{III} and references to boron include any of its isotopes, i.e., ⁶B, ⁷B, ⁸B, ⁹B, ₁₀B, ¹¹B, ¹²B, ¹³B, ¹⁴B, ¹⁵B, ¹⁶B, ¹⁷B, ¹⁸B, and ¹⁹B.

Definitions

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

The term “about,” as used herein, refers to variation in the numerical quantity that can occur, for example, through typical measuring techniques and equipment, with respect to any quantifiable variable, including, but not limited to, mass, volume, time, concentration, temperature, moles, chain length, reflectance, soil removal, surface contact angle, surface free energy, and viscosity. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

As used herein, the term “analog” means a molecular derivative of a molecule. The term is synonymous with the terms “structural analog” or “chemical analog.”

As used herein, the term “oligomer” refers to a molecular complex comprised of between one and ten monomeric units. For example, dimers, trimers, and tetramers, are considered oligomers. Furthermore, unless otherwise specifically limited, the term “oligomer” shall include all possible isomeric configurations of the molecule, including, but are not limited to isotactic, syndiotactic and random symmetries, and combinations thereof. Furthermore, unless otherwise specifically limited, the term “oligomer” shall include all possible geometrical configurations of the molecule.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

The methods and compositions of the present invention may comprise, consist essentially of, or consist of the components and ingredients of the present invention as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

With respect to the quaternary ammonium compounds, the term “alkyl” or “alkyl groups” refers only to saturated hydrocarbons having one or more carbon atoms, including straight-chain alkyl groups (e.g., methyl, ethyl, propyl, butyl, pentyl, hexyl, heptyl, octyl, nonyl, decyl, etc.), preferably octyl and decyl alkyl groups. As described herein, the alkyl groups of the quaternary ammonium compounds preferably include alkyl and dialkyl groups.

An “antiredeposition agent” refers to a compound that helps keep suspended in water instead of redepositing onto the object being cleaned. Antiredeposition agents are useful in the present invention to assist in reducing redepositing of the removed soil onto the surface being cleaned.

The term “polyol ester” refers to an ester of an organic compound containing at least two hydroxyls with at least one carboxylic acid.

The term “weight percent,” “wt. %,” “wt-%,” “percent by weight,” “% by weight,” and variations thereof, as used herein, refer to the concentration of a substance as the weight of that substance divided by the total weight of the composition and multiplied by 100.

As used herein, the term “cleaning” refers to a method used to facilitate or aid in soil removal.

As used herein, the phrase “food processing surface” refers to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing antimicrobial garment sprays, and non-to-low-aqueous food preparation lubricants, oils, and rinse additives.

As used herein, the phrase “food product” includes any food substance that might require treatment with an antimicrobial agent or composition and that is edible with or without further preparation. Food products include meat (e.g. red meat and pork), seafood, poultry, produce (e.g., fruits and vegetables), eggs, living eggs, egg products, ready to eat food, wheat, seeds, roots, tubers, leafs, stems, corns, flowers, sprouts, seasonings, or a combination thereof. The term “produce” refers to food products such as fruits and vegetables and plants or plant-derived materials that are typically sold uncooked and, often, unpackaged, and that can sometimes be eaten raw.

The term “generally recognized as safe” or “GRAS,” as used herein refers to components classified by the Food and Drug Administration as safe for direct human food consumption or as an ingredient based upon current good manufacturing practice conditions of use, as defined for example in 21 C.F.R. Chapter 1, § 170.38 and/or 570.38.

The term “hard surface” refers to a solid, substantially non-flexible surface such as a counter top, tile, floor, wall, panel, window, plumbing fixture, kitchen and bathroom furniture, appliance, engine, circuit board, dish, partitions, railings, and tables. Hard surfaces may include for example, health care surfaces and food processing surfaces.

As used herein, the phrase “health care surface” refers to a surface of an instrument, a device, a cart, a cage, furniture, a structure, a building, or the like that is employed as part of a health care activity. Examples of health care surfaces include surfaces of medical or dental instruments, of medical or dental devices, of electronic apparatus employed for monitoring patient health, and of floors, walls, or fixtures of structures in which health care occurs. Health care surfaces are found in hospital, surgical, infirmity, birthing, mortuary, and clinical diagnosis rooms. These surfaces can be those typified as “hard surfaces” (such as walls, floors, bed-pans, etc.,), or fabric surfaces, e.g., knit, woven, and non-woven surfaces (such as surgical garments, draperies, bed linens, bandages, etc.,), or patient-care equipment (such as respirators, diagnostic equipment, shunts, body scopes, wheel chairs, beds, etc.,), or surgical and diagnostic equipment. Health care surfaces include articles and surfaces employed in animal health care.

As used herein, the term “instrument” refers to the various medical or dental instruments or devices that can benefit from cleaning with a composition according to the present invention.

As used herein, the phrase “meat product” refers to all forms of animal flesh, including the carcass, muscle, fat, organs, skin, bones and body fluids and like components that form the animal. Animal flesh includes, but is not limited to, the flesh of mammals, birds, fishes, reptiles, amphibians, snails, clams, crustaceans, other edible species such as lobster, crab, etc., or other forms of seafood. The forms of animal flesh include, for example, the whole or part of animal flesh, alone or in combination with other ingredients. Typical forms include, for example, processed meats such as cured meats, sectioned and formed products, minced products, finely chopped products, ground meat and products including ground meat, whole products, and the like.

As used herein, the phrases “medical instrument,” “dental instrument,” “medical device,” “dental device,” “medical equipment,” or “dental equipment” refer to instruments, devices, tools, appliances, apparatus, and equipment used in medicine or dentistry. Such instruments, devices, and equipment can be cold sterilized, soaked or washed and then heat sterilized, or otherwise benefit from cleaning in a composition of the present invention. These various instruments, devices and equipment include, but are not limited to: diagnostic instruments, trays, pans, holders, racks, forceps, scissors, shears, saws (e.g. bone saws and their blades), hemostats, knives, chisels, rongeurs, files, nippers, drills, drill bits, rasps, burrs, spreaders, breakers, elevators, clamps, needle holders, carriers, clips, hooks, gouges, curettes, retractors, straightener, punches, extractors, scoops, keratomes, spatulas, expressors, trocars, dilators, cages, glassware, tubing, catheters, cannulas, plugs, stents, scopes (e.g., endoscopes, stethoscopes, and arthoscopes) and related equipment, and the like, or combinations thereof.

As used herein, the phrase “plant” or “plant product” includes any plant substance or plant-derived substance. Plant products include, but are not limited to, seeds, nuts, nut meats, cut flowers, plants or crops grown or stored in a greenhouse, house plants, and the like. Plant products include many animal feeds.

As used herein the term “poultry” refers to all forms of any bird kept, harvested, or domesticated for meat or eggs, and including chicken, turkey, ostrich, game hen, squab, guinea fowl, pheasant, quail, duck, goose, emu, or the like and the eggs of these birds. Poultry includes whole, sectioned, processed, cooked or raw poultry, and encompasses all forms of poultry flesh, by-products, and side products. The flesh of poultry includes muscle, fat, organs, skin, bones and body fluids and like components that form the animal. Forms of animal flesh include, for example, the whole or part of animal flesh, alone or in combination with other ingredients. Typical forms include, for example, processed poultry meat, such as cured poultry meat, sectioned and formed products, minced products, finely chopped products and whole products.

As used herein, the phrase “poultry debris” refers to any debris, residue, material, dirt, offal, poultry part, poultry waste, poultry viscera, poultry organ, fragments or combinations of such materials, and the like removed from a poultry carcass or portion during processing and that enters a waste stream.

For the purpose of this patent application, successful microbial reduction is achieved when the microbial populations are reduced by at least about 50%, or by significantly more than is achieved by a wash with water. Larger reductions in microbial population provide greater levels of protection.

As used herein, the term “soil” or “stain” refers to organic and/or inorganic soils such as a non-polar oily substance which may or may not contain particulate matter such as mineral clays, sand, natural mineral matter, carbon black, graphite, kaolin, environmental dust, dirt, etc., and food soil including proteinaceous soils, starchy soils, polysaccharides, fatty soils including saturated and unsaturated fatty soils, food particulate and matter, etc.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%, and in another embodiment, the amount of the component is less than 0.001 wt-%.

The term “substantially similar cleaning performance” refers generally to achievement by a substitute cleaning product or substitute cleaning system of generally the same degree (or at least not a significantly lesser degree) of cleanliness or with generally the same expenditure (or at least not a significantly lesser expenditure) of effort, or both.

The term “threshold agent” refers to a compound that inhibits crystallization of water hardness ions from solution, but that need not form a specific complex with the water hardness ion. Threshold agents include but are not limited to a polyacrylate, a polymethacrylate, an olefin/maleic copolymer, and the like.

The terms “vehicle” or “car” as used herein, refer to any transportation conveyance including without limitation, automobiles, trucks, sport utility vehicles, buses, trucks, motorcycles, monorails, diesel locomotives, passenger coaches, small single engine private airplanes, corporate jet aircraft, commercial airline equipment, etc.

As used herein, the term “ware” refers to items such as eating and cooking utensils, dishes, ware, drains, showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions according to the invention include but are not limited to, those that include polypropylene polymers (PP), polycarbonate polymers (PC), melamine formaldehyde resins or melamine resin (melamine), acrilonitrile-butadiene-styrene polymers (ABS), and polysulfone polymers (PS). Other exemplary plastics that can be cleaned using the compounds and compositions of the invention include polyethylene terephthalate (PET) polystyrene polyamide.

The terms “water soluble” and “water dispersible” as used herein, means that the polymer is soluble or dispersible in water in the inventive compositions. In general, the polymer should be soluble or dispersible at 25° C. at a concentration of 0.0001% by weight of the water solution and/or water carrier, preferably at 0.001%, more preferably at 0.01% and most preferably at 0.1%.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The methods, systems, apparatuses, and compositions of the present invention may comprise, consist essentially of, or consist of the components and ingredients of the present invention as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

It should also be noted that, as used in this specification and the appended claims, the term “configured” describes a system, apparatus, or other structure that is constructed or configured to perform a particular task or adopt a particular configuration. The term “configured” can be used interchangeably with other similar phrases such as arranged and configured, constructed and arranged, adapted and configured, adapted, constructed, manufactured and arranged, and the like.

Hard Surface Cleaning Compositions

The hard surface cleaning compositions comprise a surfactant blend comprising two or more of an anionic surfactant, an amphoteric surfactant, and a nonionic surfactant, an enzyme, and water. In a preferred embodiment, the hard surface cleaning compositions also comprise a biocide. The hard surface cleaning compositions can also comprise a variety of optional ingredients in some embodiments, including, but not limited to, a dye, a fragrance, a pH modifier, solvent, oxidizer, and water conditioning agent. The hard surface cleaning compositions can be prepared as solid compositions or liquid compositions. The compositions can be prepared as concentrated compositions, which can be liquid or solid. The compositions can also be prepared as ready-to-use compositions (also referred to as “RTU” or “use solutions”), which are liquid and can be prepared directly at a use concentration or by diluting a concentrated composition. Preferably, the concentrated liquid cleaning compositions have a viscosity of about 100 cps or less.

Preferably, the hard surface cleaning compositions have a pH between about 5 and about 9, more preferably between about 5.5 and about 8.5, more preferably between about 6 and about 8.2, still more preferably between about 6.5 and about 8. In a preferred embodiment, the hard surface cleaning compositions have a pH suitable for use without personal protective equipment (PPE).

We found that in order to adequately wet many of the hard surfaces that exist today, it was necessary to further reduce the surface tension of the cleaning compositions. This provided the best soil removal properties for the cleaning compositions. Further, while contact angle can be specific to the type of surface, we found that it was preferable for the cleaning compositions to generally provide a surface contact angle of less than about 50°, more preferably less than about 45°, most preferably less than about 40° after contacting the surface for about 1 second or less. In a preferred embodiment, the hard surface cleaning compositions provide a surface contact angle of about 45° or less, more preferably of about 40° or less, most preferably of about 35° after contacting the surface for about 1 seconds to about 30 seconds.

In a preferred embodiment, the hard surface cleaning compositions provide a surface contact of less than about 50°, more preferably less than about 45°, most preferably about 40° or less on a luxury vinyl tile surface after about 1 to about 30 seconds.

In a preferred embodiment, the hard surface cleaning compositions provide a surface contact of less than about 50°, more preferably about 45° or less, most preferably about 40° or less on a linoleum surface after about 1 to about 30 seconds.

In a preferred embodiment, the hard surface cleaning compositions provide a surface contact of less than about 40°, more preferably less than about 35°, still more preferably less than about 30°, even more preferably less than about 25°, most preferably less than about 20° on a grout surface after about 1 to about 30 seconds.

Each of the foregoing contact angle measurements being measured under ambient humidity and room temperature. The contact angle can be measured by any suitable method and instrument. A preferred instrument is an optical tensiometer; one commercially available optical tensiometer is the Attention® optical tensiometer sold by Biolin Scientific.

We found that it has become more difficult to remove many soils, even with similar chemistry, from porous surfaces and surfaces which are hydrophobic. While not wishing to be bound by the theory, we believe that one mechanism which can employed is imbibition where the soil is displaced by chemistry having a lower surface free energy. Thus, if the cleaning compositions have a lower surface free energy, then the soil can be displaced from the surface, including, even a porous surface or hydrophobic surface. In light of this, in a preferred embodiment, the cleaning compositions have a surface free energy lower than the hard surface substrates. For example, in a preferred embodiment, the cleaning compositions have a surface tension of less than about 28 dynes, more preferably less than about 27 dynes, still more preferably less than about 26 dynes, even more preferably about 25 dynes or less, and most preferably about 24 dynes or less.

Each of the foregoing surface tension measurements being measured under ambient humidity and room temperature. The surface tension can be measured by any suitable method and instrument. A preferred instrument is a surface tensiometer, which are commercially available from multiple sources.

Preferred embodiments of the hard surface cleaning compositions are described in Tables 1A-1C (concentrated compositions) and 2A-2C (RTU compositions) below.

TABLE 1A
Example Preferred Concentrated Compositions

| | First | Second | Third |
|---|---|---|---|
| | Exemplary | Exemplary | Exemplary |
| Ingredient | Range (wt. %) | Range (wt. %) | Range (wt. %) |
| Amphoteric Surfactant | 1-30 | 2-15 | 3-6 |
| Anionic Surfactant | 1-30 | 2-12 | 5-10 |
| Enzyme | 0.1-30 | 0.1-20 | 0.3-15 |
| Nonionic Surfactant | 0-30 | 0.1-5 | 0.5-2 |
| pH Modifier | 0-50 | 2-12 | 3-10 |
| Polycarboxylic Acid | 0-10 | 0.1-5 | 0.5-2 |
| Polymer | | | |
| Water | 10-95 | 55-90 | 60-85 |
| Optional Ingredients | 0-20 | 0.01-20 | 0.01-15 |

TABLE 1B
Example Preferred Concentrated Biocide Compositions

| | First | Second | Third |
|---|---|---|---|
| | Exemplary | Exemplary | Exemplary |
| Ingredient | Range (wt. %) | Range (wt. %) | Range (wt. %) |
| Amphoteric Surfactant | 1-30 | 2-15 | 3-6 |
| Biocide | 0.02-10 | 0.1-8 | 1-6 |
| Enzyme | 0.1-30 | 0.2-20 | 0.3-15 |
| Nonionic Surfactant | 0-30 | 0.1-5 | 0.5-2 |
| pH Modifier | 0-50 | 2-12 | 3-10 |
| Polycarboxylic Acid | 0-10 | 0.1-5 | 0.5-2 |
| Polymer | | | |
| Water | 10-95 | 55-90 | 60-85 |
| Optional Ingredients | 0-20 | 0.01-20 | 0.01-15 |
| Optional Anionic | 0-2 | 0.001-1 | 0.005-0.5 |
| Surfactant | | | |

TABLE 1C
Example Preferred Concentrated Biocide Compositions

| | First | Second | Third |
|---|---|---|---|
| | Exemplary | Exemplary | Exemplary |
| Ingredient | Range (wt. %) | Range (wt. %) | Range (wt. %) |
| Biocide | 0.02-10 | 0.1-8 | 1-6 |
| Enzyme | 0.1-30 | 0.2-20 | 0.3-15 |
| Nonionic Surfactant | 1-30 | 5-20 | 10-15 |
| pH Modifier | 0.5-15 | 1-10 | 1.5-5 |
| Solvent | 1-30 | 5-25 | 10-20 |
| Water | 10-87.5 | 55-75 | 60-70 |
| Optional Ingredients | 0-20 | 0.01-20 | 0.01-15 |

TABLE 2A
Example Preferred RTU Compositions

| | First | Second | Third |
|---|---|---|---|
| | Exemplary | Exemplary | Exemplary |
| Ingredient | Range (ppm) | Range (ppm) | Range (ppm) |
| Amphoteric Surfactant | 25-10,000 | 50-750 | 75-500 |
| Anionic Surfactant | 25-10,000 | 50-750 | 100-500 |
| Enzyme | 25-25,000 | 50-20,000 | 75-15,000 |
| Nonionic Surfactant | 0-10,000 | 1-1000 | 10-250 |
| pH Modifier | 0-10,000 | 50-750 | 75-600 |
| Polycarboxylic Acid | 0-5000 | 10-250 | 25-100 |
| Polymer | | | |
| Water | 95-99.9 wt. % | 96.5-99.9 wt. % | 98-99.5 wt. % |
| Optional Ingredients | 0-1000 | 1-750 | 5-500 |

TABLE 2B
Example Preferred RTU Biocide Compositions

| | First | Second | Third |
|---|---|---|---|
| | Exemplary | Exemplary | Exemplary |
| Ingredient | Range (ppm) | Range (ppm) | Range (ppm) |
| Amphoteric Surfactant | 25-10,000 | 50-750 | 75-500 |
| Biocide | 5-10,000 | 10-1,000 | 20-500 |
| Enzyme | 25-25,000 | 50-20,000 | 75-15,000 |
| Nonionic Surfactant | 0-10,000 | 1-1000 | 10-250 |
| pH Modifier | 0-10,000 | 50-750 | 75-600 |
| Polycarboxylic Acid | 0-5000 | 10-250 | 25-100 |
| Polymer | | | |
| Water | 95-99.9 wt. % | 96.5-99.9 wt. % | 98-99.5 wt. % |
| Optional Ingredients | 0-1000 | 1-750 | 5-500 |
| Optional Anionic | 0-200 | 1-100 | 5-50 |
| Surfactant | | | |

TABLE 2C
Example Preferred RTU Biocide Compositions

| | First | Second | Third |
|---|---|---|---|
| | Exemplary | Exemplary | Exemplary |
| Ingredient | Range (ppm) | Range (ppm) | Range (ppm) |
| Biocide | 1-10,000 | 5-1,000 | 15-500 |
| Enzyme | 5-25,000 | 10-20,000 | 25-15,000 |
| Nonionic Surfactant | 5-25,000 | 10-20,000 | 25-15,000 |
| pH Modifier | 0-10,000 | 1-750 | 10-600 |
| Solvent | 5-25,000 | 10-20,000 | 25-15,000 |
| Water | 95-99.9 wt. % | 96.5-99.9 wt. % | 98-99.5 wt. % |
| Optional Ingredients | 0-5,000 | 1-2,500 | 5-1,500 |

In a preferred embodiment, the concentrated cleaning compositions can be diluted with water to form an RTU composition. Preferably, the concentrated cleaning compositions are diluted at a dose of between about 0.5 oz and about 4 oz of concentrated composition to about 1 gallon of water; more preferably between about 0.5 oz and about 3 oz of concentrated composition to about 1 gallon of water; most preferably between about 0.5 oz and about 2.5 oz of concentrated composition to about 1 gallon of water. In another embodiment, the concentrate compositions can be diluted through any suitable dispensing equipment.

The water used to dilute the concentrate (water of dilution) can be available at the locale or site of dilution. The water of dilution may contain varying levels of hardness depending upon the locale. Service water available from various municipalities have varying levels of hardness. It is desirable to provide a concentrate that can handle the hardness levels found in the service water of various municipalities. The water of dilution that is used to dilute the concentrate can be characterized as hard water when it includes at least 1 grain hardness. It is expected that the water of dilution can include at least 5 grains hardness, at least 10 grains hardness, or at least 20 grains hardness.

Amphoteric Surfactant

The hard surface cleaning compositions can comprise an amphoteric surfactant. In a preferred embodiment comprising an amphoteric surfactant, the concentrated hard surface cleaning compositions comprise between about 1 wt. % and about 30 wt. %, more preferably between about 2 wt. % and about 15 wt. %, and most preferably between about 3 wt. % and about 6 wt. % of an amphoteric surfactant. In a preferred embodiment, the RTU hard surface cleaning compositions comprise between about 25 ppm and about 10,000 ppm, more preferably between about 50 ppm and about 750 ppm, and most preferably between about 75 ppm and about 500 ppm of an amphoteric surfactant.

Preferred amphoteric surfactants for incorporation in the hard surface cleaning compositions include, amine oxides, betaines, sultaines, or a mixture thereof.

Amine oxides are tertiary amine oxides corresponding to the general formula:

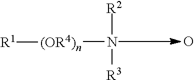

wherein the arrow is a conventional representation of a semi-polar bond; and, R¹, R², and R³ may be aliphatic, aromatic, heterocyclic, alicyclic, or combinations thereof. Generally, for amine oxides of detergent interest, R¹ is an alkyl radical of from about 8 to about 24 carbon atoms; R² and R³ are alkyl or hydroxyalkyl of 1-3 carbon atoms or a mixture thereof; R² and R³ can be attached to each other, e.g. through an oxygen or nitrogen atom, to form a ring structure; R⁴ is an alkylene or a hydroxyalkylene group containing 2 to 3 carbon atoms; and n ranges from 0 to about 20. An amine oxide can be generated from the corresponding amine and an oxidizing agent, such as hydrogen peroxide. Preferably, the amine oxide is water soluble.

Preferred water soluble amine oxide surfactants are selected from the octyl, decyl, dodecyl, isododecyl, coconut, or tallow alkyl di-(lower alkyl) amine oxides, specific examples of which are octyldimethylamine oxide, nonyldimethylamine oxide, decyldimethylamine oxide, undecyldimethylamine oxide, dodecyldimethylamine oxide, iso-dodecyldimethyl amine oxide, tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide. Preferred amine oxide surfactants include, but are not limited to, linear or branched, alkoxylated or unalkoxylated C8-C18 amine oxides.

Betaine surfactants preferably are of the general structure:

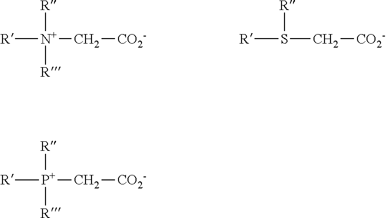

wherein R′ comprises an alkyl, alkenyl, or hydroxyalkyl radical of from 8 to 18 carbon atoms having from 0 to 10 ethylene oxide moieties and from 0 to 1 glyceryl moiety; R″ is an alkyl or monohydroxy alkyl group containing 1 to 6 carbon atoms, and R′″ is an alkylene or hydroxy alkylene or hydroxy alkylene of from 1 to 4 carbon atoms.

These surfactant betaines typically do not exhibit strong cationic or anionic characters at pH extremes nor do they show reduced water solubility in their isoelectric range. Preferred betaines include, but are not limited to, amide betaines. Examples of preferred amide betaines include, but are not limited to, coconut acylamidopropyldimethyl betaine; hexadecyl dimethyl betaine; C₁₂₋₁₄ acylamidopropylbetaine; C₈₋₁₄ acylamidohexyldiethyl betaine; 4-C₁₄₋₁₆ acylmethylamidodiethylammonio-1-carboxybutane; C₁₆₋₁₈ acylamidodimethylbetaine; C₁₂₋₁₆ acylamidopentanediethylbetaine; and C₁₂₋₁₆ acylmethylamidodimethylbetaine.

Suitable sultaines can include those compounds having the formula (R(R¹)₂ N⁺ R²SO³⁻, in which R is a C₆ -C₁₈ hydrocarbyl group, each R¹ is typically independently C₁-C₃ alkyl, e.g. methyl, and R² is a C₁-C₆ hydrocarbyl group, e.g. a C₁-C₃ alkylene or hydroxyalkylene group.

Anionic Surfactant

The hard surface cleaning compositions can comprise an anionic surfactant. Anionic surfactants are preferably included in the compositions that do not include a biocide. This is due to the interaction of the anionic surfactant with the cationic group of the biocide. With this in mind a minor amount of anionic surfactant could potentially be employed in a composition comprising a biocide, although most preferably anionic surfactant is excluded from a composition comprising a biocide. In hard surface cleaning compositions without a biocide, it is preferable to include an anionic surfactant. Anionic surfactants are surface active substances which are categorized by the negative charge on the hydrophile; or surfactants in which the hydrophilic section of the molecule carries no charge unless the pH is elevated to the pKa or above (e.g. carboxylic acids). Carboxylate, sulfonate, sulfate and phosphate are the polar (hydrophilic) solubilizing groups found in anionic surfactants. Of the cations (counter ions) associated with these polar groups, sodium, lithium and potassium impart water solubility; ammonium and substituted ammonium ions provide both water and oil solubility; and, calcium, barium, and magnesium promote oil solubility. In a preferred embodiment the surfactant is an anionic sulfonated, sulfated, or carboxylated surfactant.

In a preferred embodiment, the at least one surfactant is an anionic sulfonated surfactant. Anionic sulfonated surfactants suitable for use in the compositions also include alkyl sulfonates, the linear and branched primary and secondary alkyl sulfonates, and the aromatic sulfonates with or without substituents; sulfonates can include sulfonated carboxylic acid esters. In a preferred embodiment, suitable alkyl sulfonate surfactants include linear or branched C8-C22 alkylbenzene sulfonates, or C10-C22 alkyl sulfonates. In an exemplary aspect, the anionic alkyl sulfonate surfactant is linear alkyl benzene sulfonic acid (LAS), an alkyl olefin sulfonate (such as alpha olefin sulfonate), or a mixture thereof.

In a preferred embodiment, the at least one surfactant is an anionic sulfated surfactant. Anionic sulfated surfactants suitable for use in the compositions also include alkyl ether sulfates, alkyl sulfates (preferably C8-C18 alkyl sulfates), the linear and branched primary and secondary alkyl sulfates (preferably C8-C18), alkyl ethoxysulfates, fatty oleyl glycerol sulfates, alkyl phenol ethylene oxide ether sulfates, the C5-C₁₇ acyl-N-(C₁-C₄ alkyl) and —N-(C₁-C₂ hydroxyalkyl) glucamine sulfates, and sulfates of alkylpolysaccharides such as the sulfates of alkylpolyglucoside, and the like. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule). In some cases, the alkylene oxide bridge can be propylene oxide rather than, or in addition to ethylene oxide.

Anionic carboxylate surfactants suitable for use in the present compositions include carboxylic acids (and salts), such as alkanoic acids (and alkanoates), ester carboxylic acids (e.g. alkyl succinates), ether carboxylic acids, sulfonated fatty acids, such as sulfonated oleic acid, and the like. Such carboxylates include alkyl ethoxy carboxylates, alkyl aryl ethoxy carboxylates, alkyl polyethoxy polycarboxylate surfactants and soaps (e.g. alkyl carboxyls). Secondary carboxylates useful in the present compositions include those which contain a carboxyl unit connected to a secondary carbon. The secondary carbon can be in a ring structure, e.g. as in p-octyl benzoic acid, or as in alkyl-substituted cyclohexyl carboxylates. The secondary carboxylate surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g. N-acyl sarcosinates), taurates (e.g. N-acyl taurates and fatty acid amides of methyl tauride), and the like.

Suitable anionic surfactants include alkyl or alkylaryl ethoxy carboxylates of the following formula:

R—O—(CH₂CH₂O)ₙ(CH₂)ₘ—CO₂X (3)

in which R is a Cs to C22 alkyl group or

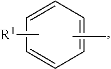

in which R¹ is a C₄-C₁₆ alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C₈-C₁₆ alkyl group. In some embodiments, R is a C12-C14 alkyl group, n is 4, and m is 1.

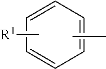

In other embodiments, R is and R¹ is a C₆-C₁₂ alkyl group. In still yet other embodiments, R¹ is a C9 alkyl group, n is 10 and m is 1. Such alkyl and alkylaryl ethoxy carboxylates are commercially available. These ethoxy carboxylates are typically available as the acid forms, which can be readily converted to the anionic or salt form. Commercially available carboxylates include, Neodox 23-4, a C₁₂₋₁₃ alkyl polyethoxy (4) carboxylic acid (Shell Chemical), and Emcol CNP-110, a C9 alkylaryl polyethoxy (10) carboxylic acid (Witco Chemical). Carboxylates are also available from Clariant, e.g. the product Sandopan® DTC, a C₁₃ alkyl polyethoxy (7) carboxylic acid.

In embodiments comprising an anionic surfactant, the concentrated hard surface cleaning compositions comprise between about 1 wt. % and about 30 wt. %, more preferably between about 2 wt. % and about 12 wt. %, and most preferably between about 5 wt. % and about 10 wt. % of an anionic surfactant. In embodiments comprising an anionic surfactant, the RTU hard surface cleaning compositions comprise between about 25 ppm and about 10,000 ppm, more preferably between about 50 ppm and about 750 ppm, and most preferably between about 100 ppm and about 500 ppm of an anionic surfactant.

Biocide

The hard surface cleaning compositions optionally comprise a biocide. In a preferred embodiment comprising a biocide, the concentrated hard surface cleaning compositions comprise between about 0.01 wt. % and about 10 wt. %, more preferably between about 0.1 wt. % and about 8 wt. %, and most preferably between about 1 wt. % and about 6 wt. % of a biocide. In a preferred embodiment comprising a biocide, the RTU hard surface cleaning compositions comprise between about 10 ppm and 10,000 ppm, more preferably between about 10 ppm and about 5000 ppm, and most preferably between about 20 ppm and about 500 ppm. In a preferred embodiment comprising a biocide, the RTU hard surface cleaning compositions comprise between about 1 ppm and 10,000 ppm, more preferably between about 5 ppm and about 5000 ppm, and most preferably between about 10 ppm and about 500 ppm.

Preferred biocides include quaternary ammonium compounds. Certain quaternary ammonium compounds (“quats”) are known to have antimicrobial activity. Accordingly, various quaternary ammonium compound with antimicrobial activity can be used in the compositions. The term “quaternary ammonium compound” or “quat” generally refers to any composition with the following formula:

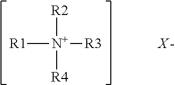

where R1-R4 each have less than a C16 chain length (or C1-C16), wherein the R1-R4 are alkyl groups and/or benzyl or alkylbenzyl groups, and X— is an anionic counterion. In an embodiment the R1-R4 groups may be alike or different, substituted or unsubstituted, saturated or unsaturated, branched or unbranched, and cyclic or acyclic and may contain ether, ester, or amide linkages; they may be aromatic or substituted aromatic groups. The term “anionic counterion” includes any ion that can form a salt with quaternary ammonium. Examples of suitable counterions include halides such as chlorides and bromides, methyl sulfates, carbonates, and bicarbonates. Preferably, the anionic counterion is chloride. In some embodiments quaternary ammoniums have carbon chains between about 1 and 16, between about 8 and 16, preferably between 8 and 12, or more preferably between 8 and 10 are included in compositions. In embodiments the quaternary ammonium compounds have R1-R4 groups with alike or different alkyl chains between about 1 and 16, between about 8 and 16, preferably between 8 and 12, and/or between 8 and 10. In embodiments, the R1-R4 alkyl groups of the quaternary ammonium compound are C1-C4 and C8-C12, such as where two alkyl groups are C1-C4 and two alkyl groups are C8-C12. In further embodiments, the R1-R4 alkyl groups of the quaternary ammonium compound are Cl and C8-C12, such as where two alkyl groups are Cl (dimethyl) and two alkyl groups are C8-C12. In further embodiments at least one of R1-R4 is a benzyl or alkylbenzyl group, wherein the benzyl or alkylbenzyl group is a methyl benzyl or ethylbenzyl.

The quaternary ammonium compounds suitable for the hard surface cleaning compositions are water soluble compounds and can further include salts of the compounds described herein. Suitable salts include, for example, salts of both inorganic and organic acids, such as nitrate, sulfate, chloride, bromide, iodide, methyl sulfate, methyl sulfonate, carbonate, bicarbonate, carboxylates, polycarboxylates, phosphates, phosphonates, and the like.

Preferred quaternary ammonium compounds comprise a di-alkyl chain quaternary ammonium compound having an R group from about 2 carbons to about 12 carbons, more preferably from about 3 carbons to about 12 carbons, most preferably from about 6 carbons to about 12 carbons and salts thereof. Preferred quaternary ammonium salts comprise, but are not limited to, bicarbonate, carboxylate, chloride, carbonate, phosphate, sulfonate, sulfate, polycarboxylate, and combinations thereof. In a preferred embodiment, the quaternary ammonium compound is an alkyl benzyl ammonium salt, a dialkyl benzyl ammonium salt, a blend of alkyl benzyl ammonium and dialkyl benzyl ammonium salts, didecyl dimethyl ammonium salt, dioctyl dimethyl ammonium salt, a blend of didecyl dimethyl ammonium and dioctyl dimethyl ammonium salts, or mixtures thereof. In a preferred embodiment the quaternary ammonium compound used in the antimicrobial compositions of the invention is comprised of a mixture of dialkyl quaternary ammonium and alkyl benzyl quaternary ammonium. In a most preferred embodiment, the quaternary ammonium salt is a chloride salt or a of carbonate and bicarbonate salts.

Examples of quaternary ammonium compounds useful in the present invention include but are not limited to alkyl (C8-C16) dimethyl benzyl ammonium chloride (ADBAC), alkyl (C8-16) dimethyl ethyl benzyl ammonium chloride (ADEBAC), and dialkyl (C8-C16) dimethyl ammonium chloride (DAAC), including octyl decyl dimethyl ammonium chloride, dioctyl dimethyl ammonium chloride, and didecyl dimethyl ammonium chloride. In preferred embodiments, the dialkyl dimethyl ammonium chloride (DAAC) is a dialkyl having C10 or less (C8-C10). In a preferred embodiment, the quaternary ammonium compound is a blend of octyl decyl dimethyl, dioctyl dimethyl, and didecyl dimethyl ammonium chloride. A single quaternary ammonium or a combination of more than one quaternary ammonium may be included in compositions.

In some embodiments depending on the nature of the R group, the anion, and the number of quaternary nitrogen atoms present, the antimicrobial quaternary ammonium compounds may be classified into one of the following categories: monoalkyltrimethyl ammonium salts; alkylmethylbenzyl ammonium salts; monoalkyldimethylbenzyl ammonium salts; dialkyldimethyl ammonium salts; heteroaromatic ammonium salts; polysubstituted quaternary ammonium salts; bis-quaternary ammonium salts; and polymeric quaternary ammonium salts. Each category will be discussed herein.

Monoalkyltrimethyl ammonium salts contain one R group that is a long-chain alkyl group, and the remaining R groups are short-chain alkyl groups, such as methyl or ethyl groups. Some non-limiting examples of monoalkyltrimethyl ammonium salts include cetyltrimethylammonium bromide, commercially available under the tradenames Rhodaquat M242C/29 and Dehyquart A; alkyltrimethyl ammonium chloride, commercially available as Arquad 16; alkylaryltrimethyl ammonium chloride; and cetyldimethyl ethylammonium bromide, commercially available as Ammonyx DME.

Monoalkyldimethylbenzyl ammonium salts contain one R group that is a long-chain alkyl group, a second R group that is a benzyl or alkylbenzyl group, and the two remaining R groups are short-chain alkyl groups, such as methyl or ethyl groups. Monoalkyldimethylbenzyl ammonium salts are generally compatible with nonionic surfactants, detergent builders, perfumes, and other ingredients. Some non-limiting examples of monoalkyldimethylbenzyl ammonium salts include alkyldimethylbenzyl ammonium chlorides, commercially available as Barquat from Lonza Inc.; and benzethonium chloride, commercially available as Lonzagard, from Lonza Inc. Additionally, the monoalkyldimethylbenzyl ammonium salts may be substituted. Non-limiting examples of such salts include dodecyldimethyl-3,4-dichlorobenzyl ammonium chloride. Finally, there are mixtures of alkyldimethylbenzyl and alkyldimethyl substituted benzyl (ethylbenzyl) ammonium chlorides commercially available as BTC 2125M from Stepan Company, and Barquat 4250 from Lonza Inc.

Dialkyldimethyl ammonium salts contain two R groups that are long-chain alkyl groups, and the remaining R groups are short-chain alkyl groups, such as methyl groups. Preferred quaternary ammonium salts comprise, but are not limited to, bicarbonate, carboxylate, chloride, carbonate, phosphate, sulfonate, sulfate, polycarboxylate, and combinations thereof. Some non-limiting examples of dialkyldimethyl ammonium salts include didecyldimethyl ammonium halides, commercially available as Bardac 22 from Lonza Inc.; didecyl dimethyl ammonium chloride commercially available as Bardac 2250 from Lonza Inc.; didecyl dimethyl ammonium carbonate and didecyl dimethyl ammonium bicarbonate commercially available as Carobquat H from Lonza Inc.; dioctyl dimethyl ammonium chloride, commercially available as Bardac LF and Bardac LF-80 from Lonza Inc.); and octyl decyl dimethyl ammonium chloride sold as a mixture with didecyl and dioctyl dimethyl ammonium chlorides, commercially available as Bardac 2050 and 2080 from Lonza Inc.

Nonionic Surfactant

The hard surface cleaning compositions can comprise a nonionic surfactant. In a preferred embodiment comprising a nonionic surfactant, the concentrated hard surface cleaning compositions comprise between about 0.01 wt. % and about 30 wt. %, more preferably between about 0.1 wt. % and about 5 wt. %, and most preferably between about 0.5 wt. % and about 2 wt. % of a nonionic surfactant. In a preferred embodiment comprising a nonionic, the RTU hard surface cleaning compositions comprise between about 0.1 ppm and about 10,000 ppm, more preferably between about 1 ppm and about 1000 ppm, and most preferably between about 10 ppm and about 250 ppm of a nonionic surfactant.

In another preferred embodiment comprising a nonionic surfactant, the concentrated hard surface cleaning compositions comprise between about 1 wt. % and about 30 wt. %, more preferably between about 5 wt. % and about 20 wt. %, and most preferably between about 10 wt. % and about 15 wt. % of a nonionic surfactant. In a preferred embodiment comprising a nonionic, the RTU hard surface cleaning compositions comprise between about 5 ppm and about 25,000 ppm, more preferably between about 10 ppm and about 20,000 ppm, and most preferably between about 25 ppm and about 15,000 ppm of a nonionic surfactant.

Preferred nonionic surfactants are low foaming. Examples of nonionic low foaming surfactants include:

1. Compounds from (1) which are modified, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1,000 to about 3,100 with the central hydrophile including 10% by weight to about 80% by weight of the final molecule. These reverse Pluronics™ are manufactured by BASF Corporation under the trade name Pluronic™ R surfactants. Likewise, the Tetronic™ R surfactants are produced by BASF Corporation by the sequential addition of ethylene oxide and propylene oxide to ethylenediamine. The hydrophobic portion of the molecule weighs from about 2,100 to about 6,700 with the central hydrophile including 10% by weight to 80% by weight of the final molecule.

2. Compounds from groups (1), (2), (3) and (4) which are modified by “capping” or “end blocking” the terminal hydroxy group or groups (of multi-functional moieties) to reduce foaming by reaction with a small hydrophobic molecule such as propylene oxide, butylene oxide, benzyl chloride; and, short chain fatty acids, alcohols or alkyl halides containing from 1 to about 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics. 3. The alkylphenoxypolyethoxyalkanols of U.S. Pat. No. 2,903,486 issued Sep. 8, 1959 to Brown et al. and represented by the formula

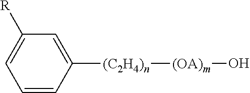

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962 to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

The defoaming nonionic surfactants disclosed in U.S. Pat. No. 3,382,178 issued May 7, 1968 to Lissant et al. having the general formula Z[(OR)ₙOH]_{z} wherein Z is alkoxylatable material, R is a radical derived from an alkaline oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954 to Jackson et al. corresponding to the formula Y(C₃H₆O)ₙ (C₂H₄O)ₘH wherein Y is the residue of organic compound having from about 1 to 6 carbon atoms and one reactive hydrogen atom, n has an average value of at least about 6.4, as determined by hydroxyl number and m has a value such that the oxyethylene portion constitutes about 10% to about 90% by weight of the molecule.

The conjugated polyoxyalkylene compounds described in U.S. Pat. No. 2,674,619, issued Apr. 6, 1954 to Lundsted et al. having the formula Y[(C₃H₆Oₙ (C₂H₄O)ₘH]ₓ wherein Y is the residue of an organic compound having from about 2 to 6 carbon atoms and containing x reactive hydrogen atoms in which x has a value of at least about 2, n has a value such that the molecular weight of the polyoxypropylene hydrophobic base is at least about 900 and m has value such that the oxyethylene content of the molecule is from about 10% to about 90% by weight. Compounds falling within the scope of the definition for Y include, for example, propylene glycol, glycerine, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

Additional conjugated polyoxyalkylene surface-active agents which are advantageously used in the compositions of this invention correspond to the formula: P[(C₃H₆O)ₙ(C₂H₄O)ₘH]ₓ wherein P is the residue of an organic compound having from about 8 to 18 carbon atoms and containing x reactive hydrogen atoms in which x has a value of 1 or 2, n has a value such that the molecular weight of the polyoxyethylene portion is at least about 44 and m has a value such that the oxypropylene content of the molecule is from about 10% to about 90% by weight. In either case the oxypropylene chains may contain optionally, but advantageously, small amounts of ethylene oxide and the oxyethylene chains may contain also optionally, but advantageously, small amounts of propylene oxide.

4. Polyhydroxy fatty acid amide surfactants suitable for use in the present compositions include those having the structural formula R₂CON_{R1}Z in which: R1 is H, C₁-C₄ hydrocarbyl, 2-hydroxy ethyl, 2-hydroxy propyl, ethoxy, propoxy group, or a mixture thereof R₂ is a C₅-C₃₁ hydrocarbyl, which can be straight-chain; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction; such as a glycityl moiety.

5. The alkyl ethoxylate condensation products of aliphatic alcohols with from about 0 to about 25 moles of ethylene oxide are suitable for use in the present compositions. The alkyl chain of the aliphatic alcohol can either be straight or branched, primary or secondary, and generally contains from 6 to 22 carbon atoms.

6. The ethoxylated C₆-C₁₈ fatty alcohols and C₆-C₁₈ mixed ethoxylated and propoxylated fatty alcohols are suitable surfactants for use in the present compositions, particularly those that are water soluble. Suitable ethoxylated fatty alcohols include the C₆-C₁₈ ethoxylated fatty alcohols with a degree of ethoxylation of from 3 to 50.

7. Suitable nonionic alkylpolysaccharide surfactants, particularly for use in the present compositions include those disclosed in U.S. Pat. No. 4,565,647, Llenado, issued Jan. 21, 1986. These surfactants include a hydrophobic group containing from about 6 to about 30 carbon atoms and a polysaccharide, e.g., a polyglycoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units.

8. Fatty acid amide surfactants suitable for use the present compositions include those having the formula: R₆CON(R₇)₂ in which R₆ is an alkyl group containing from 7 to 21 carbon atoms and each R₇ is independently hydrogen, C₁-C₄ alkyl, C₁-C₄ hydroxyalkyl, or —(C₂H₄O)ₓH, where x is in the range of from 1 to 3.

9. A useful class of non-ionic surfactants include the class defined as alkoxylated amines or, most particularly, alcohol alkoxylated/aminated/alkoxylated surfactants. These non-ionic surfactants may be at least in part represented by the general formulae: R²⁰—(PO)ₛN-(EO)ₜH, R²⁰—(PO)ₛN-(EO)ₜH(EO)ₜH, and R²⁰—N(EO)ₜH; in which R²⁰ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, t is 1-10, preferably 2-5, and u is 1-10, preferably 2-5. Other variations on the scope of these compounds may be represented by the alternative formula: R²⁰—(PO)ᵥ—N[(EO)_{w} H][(EO)_{z}H] in which R²⁰ is as defined above, v is 1 to 20 (e.g., 1, 2, 3, or 4 (preferably 2)), and w and z are independently 1-10, preferably 2-5. These compounds are represented commercially by a line of products sold by Huntsman Chemicals as nonionic surfactants. Preferred nonionic surfactants for the compositions of the invention include alcohol alkoxylates, EO/PO block copolymers, alkylphenol alkoxylates, and the like.

Preferred nonionic surfactants comprise alkoxyated surfactants and alkyl polyglycosides. Preferred alkoxylated surfactants comprise ethylene, propylene, butylene oxide, or mixtures thereof. Most preferred alkoxylated surfactants have between about 8 carbons and about 18 carbons and can be linear or branched. Preferred alkoxylated surfactants include EO/PO copolymers, capped EO/PO copolymers, alcohol alkoxylates, capped alcohol alkoxylates, extended alkoxylates, mixtures thereof.

Enzymes

In some embodiments, the compositions of the present disclosure include an enzyme. Preferred enzymes include proteases, amylases, cellulases, lipases, and combinations of the same. More preferred enzymes are proteases. The enzyme is preferably in an amount between about 0 wt. % to about 30 wt. %, from about 0.1 wt. % to about 20 wt. %, or from about 0.3 wt. % to about 15 wt. %.

Proteases

Any protease or mixture of proteases, from any source, can be used in the enzymatic detergent compositions, provided that the selected enzyme is stable in the desired pH range (between about 6 and about 9). For example, the protease enzymes can be derived from a plant, an animal, or a microorganism such as a yeast, a mold, or a bacterium. Preferred protease enzymes include, but are not limited to, the enzymes derived from Bacillus subtilis, Bacillus licheniformis and Streptomyces griseus. Protease enzymes derived from B. subtilis are most preferred. The protease can be purified or a component of a microbial extract, and either wild type or variant (either chemical or recombinant). Exemplary proteases are commercially available under the following trade names Excellase™, Properase™ Purafect™, Purafect™ Prime, Purafect™ Ox each available from Genencor and Alcalase®, Blaze®, Evity®, Savinase®, Esperase®, Liquinase™, Ovozyme™, Everlase™, Release™, Polarzyme™, Coronase™, and Progress UNO™ (also sold under the name Everis DUO™) each available from Novozymes.

Amylases

Any amylase or mixture of amylases, from any source, can be used in the enzymatic detergent compositions, provided that the selected enzyme is stable in the desired pH range (between about 6 and about 9). For example, the amylase enzymes can be derived from a plant, an animal, or a microorganism such as a yeast, a mold, or a bacterium. Preferred amylase enzymes include, but are not limited to, those derived from a Bacillus, such as B. licheniformis, B. amyloliquefaciens, B. subtilis, or B. stearothermophilus. Amylase enzymes derived from B. subtilis are most preferred. The amylase can be purified or a component of a microbial extract, and either wild type or variant (either chemical or recombinant). Preferred amylases are commercially available under the trade name Stainzyme® available from Novozymes.

Cellulases

Any cellulase or mixture of cellulases, from any source, can be used in the enzymatic detergent compositions, provided that the selected enzyme is stable in the desired pH range (between about 6 and about 9). For example, the cellulase enzymes can be derived from a plant, an animal, or a microorganism such as a fungus or a bacterium. Preferred cellulase enzymes include, but are not limited to, those derived from Humicola insolens, Humicola strain DSM1800, or a cellulase 212-producing fungus belonging to the genus Aeromonas and those extracted from the hepatopancreas of a marine mollusk, Dolabella Auricula Solander. The cellulase can be purified or a component of a microbial extract, and either wild type or variant (either chemical or recombinant).

Lipases

Any lipase or mixture of lipases, from any source, can be used in the enzymatic detergent compositions, provided that the selected enzyme is stable in the desired pH range (between about 6 and about 9). For example, the lipase enzymes can be derived from a plant, an animal, or a microorganism such as a fungus or a bacterium. Preferred protease enzymes include, but are not limited to, the enzymes derived from a Pseudomonas, such as Pseudomonas stutzeri ATCC 19.154, or from a Humicola, such as Humicola lanuginosa (typically produced recombinantly in Aspergillus oryzae). The lipase can be purified or a component of a microbial extract, and either wild type or variant (either chemical or recombinant).

Other Enzymes

The enzymatic detergent compositions can comprise additional enzymes in addition to the foregoing. Additional suitable enzymes can include, but are not limited to, cutinases, peroxidases, gluconases, or mixtures thereof.

pH Modifier

In some embodiments, the hard surface cleaning compositions can optionally comprise a pH modifier. The pH modifier chosen can be based on the desired pH of the compositions. In another aspect of the invention, a pH modifier can be as a neutralizer. Suitable pH modifiers include an acid source, an alkalinity source, or a mixture thereof.

Acid Source

In some embodiments, the hard surface cleaning compositions can optionally include an acid source. In some embodiments of the invention, a cleaning composition can have an acidic pH. In such an embodiment, the pH is preferably between 3 and 7. In another aspect of the invention, the acid source can be included as a pH modifier or neutralizer in a basic composition to achieve a desired pH.

Suitable acid sources, can include, organic and/or inorganic acids. Examples of suitable organic acids include carboxylic acids such as but not limited to hydroxyacetic (glycolic) acid, citric acid, formic acid, acetic acid, propionic acid, butyric acid, valeric acid, caproic acid, trichloroacetic acid, urea hydrochloride, and benzoic acid, among others. Organic dicarboxylic acids such as oxalic acid, malonic acid, gluconic acid, itaconic acid, succinic acid, glutaric acid, maleic acid, fumaric acid, adipic acid, and terephthalic acid among others are also useful in accordance with the invention. Any combination of these organic acids may also be used intermixed or with other organic acids which allow adequate formation of the composition of the invention.

Inorganic acids useful in accordance with the invention include sulfuric acid, sulfamic acid, methylsulfamic acid, hydrochloric acid, hydrobromic acid, and nitric acid among others. These acids may also be used in combination with other inorganic acids or with those organic acids mentioned above. In a preferred embodiment, the acid is an inorganic acid.

If included in the concentrated hard surface cleaning composition, the acid source is preferably in a concentration between about 0.01 wt. % and about 10 wt. %, more preferably between about 0.1 wt. % and about 8 wt. %. If included in the RTU hard surface cleaning composition, the acid source is preferably in a concentration between about 0.1 ppm and about 1000 ppm, more preferably between about 1 ppm and about 500 ppm.

Alkalinity Source

The cleaning compositions can optionally include an alkalinity source. Suitable alkalinity sources include weak bases and strong bases. In a preferred embodiment, the hard surface cleaning compositions comprise both a weak base and a solid base. Examples of suitable alkalinity sources of the cleaning composition include, but are not limited to carbonate-based alkalinity sources, including, for example, carbonate salts such as alkali metal carbonates; caustic-based alkalinity sources, including, for example, alkali metal hydroxides; other suitable alkalinity sources may include metal silicate, metal borate, and organic alkalinity sources. Exemplary alkali metal carbonates that can be used include, but are not limited to, sodium carbonate, potassium carbonate, bicarbonate, sesquicarbonate, and mixtures thereof. Exemplary alkali metal hydroxides that can be used include, but are not limited to sodium, lithium, or potassium hydroxide. Exemplary metal silicates that can be used include, but are not limited to, sodium or potassium silicate or metasilicate. Exemplary metal borates include, but are not limited to, sodium or potassium borate.

Organic alkalinity sources are often strong nitrogen bases including, for example, ammonia (ammonium hydroxide), amines, alkanolamines, and amino alcohols. Typical examples of amines include primary, secondary or tertiary amines and diamines carrying at least one nitrogen linked hydrocarbon group, which represents a saturated or unsaturated linear or branched alkyl group having at least 10 carbon atoms and preferably 16-24 carbon atoms, or an aryl, aralkyl, or alkaryl group containing up to 24 carbon atoms, and wherein the optional other nitrogen linked groups are formed by optionally substituted alkyl groups, aryl group or aralkyl groups or polyalkoxy groups. Typical examples of alkanolamines include monoethanolamine, monopropanolamine, diethanolamine, dipropanolamine, triethanolamine, tripropanolamine and the like. Typical examples of amino alcohols include 2-amino-2-methyl-1-propanol, 2-amino-1-butanol, 2-amino-2-methyl-1,3-propanediol, 2-amino-2-ethyl-1,3-propanediol, hydroxymethyl aminomethane, and the like.

In general, alkalinity sources are commonly available in either aqueous or powdered form. The alkalinity can be added to the composition in any form known in the art, including as solid beads, granulated or particulate form, dissolved in an aqueous solution, or a combination thereof.

The alkalinity source can be included in the hard surface cleaning compositions in any amount needed to achieve the desired pH of the compositions. In a preferred embodiment, the concentrated hard surface cleaning compositions comprise between about 0 wt. % and about 50 wt. %, more preferably between about 2 wt. % and about 12 wt. %, and most preferably between about 3 wt. % and about 10 wt. % of an alkalinity source. In a preferred embodiment, the RTU hard surface cleaning compositions comprise between about 0 ppm and about 10,000 ppm, more preferably between about 1 ppm and about 750 ppm, and most preferably between about 10 ppm and about 600 ppm of an alkalinity source.

Additional Optional Ingredients

In embodiments of the invention, additional ingredients can be included in the hard surface cleaning compositions. The additional ingredients provide desired properties and functionalities to the compositions. For the purpose of this application, the term “functional ingredient” includes a material that provides a beneficial property in a particular use. Some particular examples of functional materials are discussed in more detail below, although the particular materials discussed are given by way of example only, and that a broad variety of other functional ingredients may be used. Examples of such a functional materials include, but are not limited to, a dye, a fragrance, an oxidizer, a solvent, a water conditioning agent, or mixtures thereof. A broad variety of other functional materials may also be included or excluded depending upon the desired characteristics and/or functionality of the composition. In a preferred embodiment, the compositions are substantially free of, or entirely free of, one or more of the following: cationic surfactants, silicon-based polymers and surfactants, foam boosters, ionic salts, and/or rheology modifiers.

In the context of some embodiments disclosed herein, the functional materials, or ingredients, are optionally included within the hard surface cleaning compositions for their functional properties. Some more particular examples of functional materials are discussed in more detail below, but it should be understood by those of skill in the art and others that the particular materials discussed are given by way of example only, and that a broad variety of other functional materials may be used.

The amount of a particular optional functional ingredient can vary depending on the nature of the ingredient and property intended for the composition. Despite this it is generally expected that the concentrated hard surface cleaning compositions comprise between 0 wt. % and about 20 wt. %, about 0.01 wt. % and about 20 wt. %, 0.01 wt. % and about 15 wt. % additional functional ingredients. Similarly, in an RTU hard surface cleaning compositions comprise between 0 ppm and about 1000 ppm, about 0.1 ppm and about 1000 ppm, 1 ppm and about 750 ppm, 5 ppm and about 500 ppm additional functional ingredients.

Dyes

The hard surface cleaning compositions can optionally comprise a dye or colorant. Various dyes and other aesthetic enhancing agents can be included in the hard surface cleaning compositions. Dyes may be included to alter the appearance of the composition, as for example, FD&C Blue 1 (Sigma Chemical), FD&C Yellow 5 (Sigma Chemical), Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keyston Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), Acid Green 25 (Ciba-Geigy), Liquitint Green 1054, and the like.

If included in the concentrated hard surface cleaning composition, a dye is preferably in a concentration between about 0.001 wt. % and about 5 wt. %, more preferably between about 0.01 wt. % and about 2 wt. %. If included in the RTU hard surface cleaning composition, a dye is preferably in a concentration between about 0.0001 ppm and about 100 ppm, more preferably between about 0.001 ppm and about 50 ppm.

Fragrances

The hard surface cleaning compositions can optionally comprise a fragrance. Various fragrances, odorants, perfumes, and other odor enhancing agents can be included in the hard surface cleaning compositions. Preferred fragrances include, but are not limited to, terpenoids such as citronellol, aldehydes such as amyl cinnamaldehyde, a jasmine such as C1S-jasmine or jasmal, vanillin, fruit fragrances whether natural or synthetic, vegetable fragrances whether natural or synthetic, herb or spice fragrances whether natural or synthetic, and the like.

If included in the concentrated hard surface cleaning composition, a fragrance is preferably in a concentration between about 0.01 wt. % and about 5 wt. %, more preferably between about 0.1 wt. % and about 2 wt. %. If included in the RTU hard surface cleaning composition, a fragrance is preferably in a concentration between about 0.01 ppm and about 200 ppm, more preferably between about 0.1 ppm and about 100 ppm.

Oxidizer

The hard surface cleaning compositions can optionally include an oxidizer. If included in the concentrated hard surface cleaning compositions, the oxidizer is preferably in a concentration between about 0 wt. % and about 10 wt. %, more preferably between about 0.1 wt. % and about 7 wt. %.

Oxidizers can be used for lightening or whitening a substrate and can include active oxygen compounds and bleaching compounds capable of liberating an active halogen species, such as Cl₂, Br₂, —OCl⁻ and/or —OBr⁻, or the like, under conditions typically encountered during the cleansing process. Suitable active oxygen compounds can be inorganic or organic, or can be a mixture thereof. Some examples of active oxygen compound include peroxygen compounds, or peroxygen compound adducts. Some examples of active oxygen compounds or sources include hydrogen peroxide, perborates, sodium carbonate peroxyhydrate, phosphate peroxyhydrates, potassium permonosulfate, and sodium perborate mono and tetrahydrate, with and without activators such as tetraacetylethylene diamine, and the like. Suitable bleaching compounds can include, for example, chlorine-containing compounds such as a chlorine, a hypochlorite, chloramines, of the like. Some examples of halogen-releasing compounds include the alkali metal dichloroisocyanurates, chlorinated trisodium phosphate, the alkali metal hypochlorites, monochloramine and dichloroamine, and the like. Encapsulated chlorine sources may also be used to enhance the stability of the chlorine source in the composition (see, for example, U.S. Pat. Nos. 4,618,914 and 4,830,773, the disclosures of which are incorporated by reference herein). Preferred oxidizers include, but are not limited to, peroxide-based oxidizers, chlorine-based oxidizers, or a combination thereof.

Sequestrants

The composition can contain an organic or inorganic sequestrant or mixtures of sequestrants. Organic sequestrants such as sodium citrate, the alkali metal salts of nitrilotriacetic acid (NTA), dicarboxymethyl glutamic acid tetrasodium salt (GLDA), EDTA, alkali metal gluconates, polyelectrolytes such as a polyacrylic acid, and the like can be used herein. The most preferred sequestrants are organic sequestrants such as sodium gluconate due to the compatibility of the sequestrant with the formulation base.

The present disclosure can also incorporate sequestrants to include materials such as, complex phosphate sequestrants, including sodium tripolyphosphate, sodium hexametaphosphate, and the like, as well as mixtures thereof. Phosphates, the sodium condensed phosphate hardness sequestering agent component functions as a water softener, a cleaner, and a detergent builder. Alkali metal (M) linear and cyclic condensed phosphates commonly have a M₂O: P₂ O₅ mole ratio of about 1:1 to 2:1 and greater. Typical polyphosphates of this kind are the preferred sodium tripolyphosphate, sodium hexametaphosphate, sodium metaphosphate as well as corresponding potassium salts of these phosphates and mixtures thereof. The particle size of the phosphate is not critical, and any finely divided or granular commercially available product can be employed.

Solvent

The hard surface cleaning compositions can optionally include a solvent. If included in the concentrated hard surface cleaning compositions, the solvent is preferably in a concentration between about 0 wt. % and about 20 wt. %. We have found that inclusion of a solvent can aid in stabilizing the enzyme within the composition. Preferred solvents include, but are not limited to, organic solvents including, but not limited to diols, polyols, aromatic alcohols, and mixtures thereof.

In a preferred embodiment, the solvent is a hydrophobic oxygenated solvent. Exemplary solvents and solvent systems include limited water-solubility alcohols. In an aspect, a benzyl alcohol solvent and/or solvent system is employed. In a further aspect, a phenoxyethanol solvent and/or solvent system is employed. Without being limited to a particular mechanism of action, in some embodiments, the solvent provides a limited water solubility alcohol providing hydrophobicity that adds affinity towards greasy soils and acts as a plasticizer.

Additional suitable solvents and solvent systems may include one or more different solvents including aromatic alcohols, ether amines, amidines, esters, glycol ethers, and mixtures thereof. Representative glycol ether solvents may include aromatic glycol ether solvents, such as ethylene glycol phenyl ether (commercially available from Dow as Dowanol Eph) or diethylene glycol phenyl ether (commercially available as Dowanol DiEPh). Additional suitable glycol ether solvents may include, without limitation, Butyl CARBITOL™ acetate, Butyl CARBITOL™, Butyl CELLOSOLVE™ acetate, Butyl CELLOSOLVE™, Butyl DIPROPASOL™, Butyl PROPASOL™, CARBITOL™ PM-600, CARBITOL™ Low Gravity, further comprises a buffering agent, a cosolvent, a coupling agent, a defoaming agent, a dye, a fragrance, a foaming agent, a hydrotrope, a pH adjusting agent, a solubilizer, an additional surfactant, a wetting agent, or mixture thereof CELLOSOLVE™, DOWANOL PPH™, DOWANOL TPnB™, EEP™, FILMER IBT™, Hexyl CARBITOL™, Hexyl CELLOSOLVE™, Methyl CARBITOL™, Methyl CELLOSOLVE™ acetate, Methyl CELLOSOLVE™, Methyl DIPROPASOL™, Methyl PROPASOL acetate, Methyl PROPASOL™, Propyl CARBITOL™, Propyl CELLOSOLVE™, Propyl DIPROPASOL™, and/or Propyl PROPASOL™.

Additional suitable solvents may include 1,8-Diazabicyclo[5.4.0]undec-7-ene, or also may be referred to as 2,3,4,6,7,8,9,10-Octahydropyrimidol[1,2-a]azepine (or DBU), 2.5.7.10-tetraoxaundecante (TOU), acetamidophenol, acetanilide, acetophenone, 2-acetyl-1-methylpyrrole, ethyl hexyl glycerine, benzyl acetate, benzyl alcohol, methyl benzyl alcohol, alpha phenyl ethanol, benzyl benzoate, benzyloxyethanol, ethylene glycol phenyl ether, a propylene glycol, propylene glycol phenyl ether, amyl acetate, amyl alcohol, 3-butoxyethyl-2-propanol, butyl acetate, n-butyl propionate, cyclohexanone, diacetone alcohol, diethoxyethanol, diethylene glycol methyl ether, diisobutyl carbinol, diisobutyl ketone, dimethyl heptanol, dipropylene glycol tert-butyl ether, 2-ethylhexanol, ethyl propionate, ethylene glycol methyl ether acetate, hexanol, isobutanol, isobutyl acetate, isobutyl heptyl ketone, isophorone, isopropanol, isopropyl acetate, methanol, methyl amyl alcohol, methyl n-amyl ketone, 2-methyl-1-butanol, methyl ethyl ketone, methyl isobutyl ketone, 1-pentanol, n-pentyl propionate, 1-propanol, n-propyl acetate, n-propyl propionate, propylene glycol ethyl ether, tripropylene glycol methyl ether, dipropylene glycol n-propyl ether, tripropylene glycol n-propyl ether, dipropylene glycol n-butyl ether, tripropylene glycol n-butyl ether, diethylene glycol n-butyl ether acetate, diethylene glycol monobutyl ether, ethylene glycol n-butyl ether acetate, ethylene glycol monobutyl ether, dipropylene glycol monobutyl ether, propylene glycol monobutyl ether, ethyl 3-ethoxypropionate, 2,2,4-Trimethyl-1,3-Pentanediol Monoisobutyrate, diethylene glycol monohexyl ether, ethylene glycol monohexyl ether, diethylene glycol monomethyl ether, diethylene glycol monoethyl ether, ethylene glycol methyl ether acetate, ethylene glycol monomethyl ether, dipropylene glycol monomethyl ether, propylene glycol methyl ether acetate, propylene glycol monomethyl ether, diethylene glycol monopropyl ether, ethylene glycol monopropyl ether, dipropylene glycol monopropyl ether and propylene glycol monopropyl ether. Representative dialkyl carbonates include dimethyl carbonate, diethyl carbonate, dipropyl carbonate, diisopropyl carbonate and dibutyl carbonate. Representative oils include benzaldehyde, pinenes (alphas, betas, etc.), terpineols, terpinenes, carvone, cinnamealdehyde, borneol and its esters, citrals, ionenes, jasmine oil, limonene, dipentene, linalool and its esters. Representative dibasic esters include dimethyl adipate, dimethyl succinate, dimethyl glutarate, dimethyl malonate, diethyl adipate, diethyl succinate, diethyl glutarate, dibutyl succinate, dibutyl glutarate and products available under the trade designations DBE, DBE-3, DBE-4, DBE-5, DBE-6, DBE-9, DBE-IB, and DBE-ME from DuPont Nylon. Representative phthalate esters include dibutyl phthalate, diethylhexyl phthalate and diethyl phthalate. Additional solvents include glycerin and glycerin mono alkyl ethers such as mono heptyl glycerin, and 1,2 alkane diols such as 1,2 octane diol.

In a preferred embodiment, the solvent is one or more of benzyl alcohol and/or a solvent from the Dowanol E series and/or Dowanol P series.

Water Conditioning Agent

In some embodiments, the hard surface cleaning compositions can optionally comprise a water conditioning agent. Preferred water conditioning agents, include, but are not limited to aminocarboxylates, condensed phosphates, phosphonates, polycarboxylic acid polymers, or a mixture thereof.

Preferred aminocarboxylates include, but are not limited to, ethylenediaminetetra-acetates (EDTA), glutamic-N,N-diacetic acid (GLDA) N-hydroxyethylethylenediaminetriacetates (HEDTA), methyl-glycine-diacetic acid (MGDA), nitrilo-triacetates (NTA), ethylenediamine tetrapro-prionates, triethylenetetraaminehexacetates, diethylenetriaminepentaacetates, and ethanoldi-glycines, salts and derivatives of the foregoing, alkali metal, ammonium, and substituted ammonium salts therein and mixtures thereof.

Preferred condensed phosphates include, but are not limited to, sodium and potassium orthophosphate, sodium and potassium pyrophosphate, sodium tripolyphosphate, sodium hexametaphosphate, and the like.

Preferred phosphonates, include, but are not limited to, 1-hydroxyethane-1,1-diphosphonic acid CH₃C(OH)[PO(OH)₂]₂; aminotri(methylenephosphonic acid) N[CH₂PO(OH)₂]₃; aminotri(methylenephosphonate), sodium salt

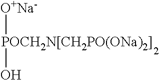

2-hydroxyethyliminobis(methylenephosphonic acid) HOCH₂ CH₂ N[CH₂ PO(OH)₂]₂; diethylenetriaminepenta(methylenephosphonic acid) (HO)₂ POCH₂ N[CH₂ N[CH₂PO(OH)₂]₂]₂; diethylenetriaminepenta(methylenephosphonate), sodium salt C₉ H₍₂₈₋ₓ₎ N₃NaₓO₁₅P₅ (x=7); hexamethylenediamine(tetramethylenephosphonate), potassium salt C₁₀ H₍₂₈₋ₓ₎N₂KₓO₁₂P₄ (x=6); bis(hexamethylene)triamine(pentamethylenephosphonic acid) (HO₂)POCH₂N[(CH₂)₆N[CH₂ PO(OH)₂]₂]₂; and phosphorus acid H₃PO₃. In some embodiments, a phosphonate combination such as ATMP and DTPMP may be used.

Suitable polycarboxylic acid polymer can be a homopolymer, copolymer, and/or terpolymer comprising polyacrylic acid, polymaleic acid, or a combination thereof. Preferred polycarboxylic acid polymers include a polyacrylic acid polymer having a weight average molecular weight of about 1,000 to about 100,000, a modified polyacrylic acid polymer having a weight average molecular weight of about 1,000 to about 100,000, or a polymaleic acid polymer having a weight average molecular weight of about 500 to about 5,000. In a most preferred embodiment, the water conditioning agent comprises a polycarboxylic acid polymer comprising a polymaleci acid polymer.

Examples of a suitable polycarboxylic acid polymer include: polyacrylic acid polymers, polyacrylic acid polymers modified by a fatty acid end group (“modified polyacrylic acid polymers”), and polymaleic acid polymers. Examples of suitable polyacrylic acid polymers and modified polyacrylic acid polymers include those having a weight average molecular weight of about 1,000 to about 100,000. Examples of suitable polymaleic acid polymers include those having a weight average molecular weight of about 500 to about 5,000. Suitable polycarboxylic acid polymers are available under the trade name Acusol, available from Rohm & Haas LLC, Philadelphia, Pa. and Belclene, available from Houghton Chemical Corporation, Boston, Mass.

The hard surface cleaning compositions optionally comprise a polycarboxylic acid polymer. In a preferred embodiment comprising a polycarboxylic acid polymer, the concentrated hard surface cleaning compositions comprise between about 0.01 wt. % and about 10 wt. %, more preferably between about 0.1 wt. % and about 5 wt. %, and most preferably between about 0.5 wt. % and about 2 wt. % of a polycarboxylic acid polymer. In a preferred embodiment comprising a nonionic, the RTU hard surface cleaning compositions comprise between about 0.1 ppm and about 5000 ppm, more preferably between about 1 ppm and about 250 ppm, and most preferably between about 10 ppm and about 100 ppm of a polycarboxylic acid polymer.

Methods of Making the Hard Surface Cleaning Compositions

The hard surface cleaning compositions can be prepared by any suitable method of preparation depending on the type of product to be prepared (i.e., liquid, solid, concentrated or use solution). For example, liquid compositions can typically be made by forming the ingredients in an aqueous liquid or aqueous liquid solvent system. Such systems are typically made by dissolving or suspending the active ingredients in water or in compatible solvent and then diluting the product to an appropriate concentration, either to form a concentrate or a use solution thereof. Gelled compositions can be made similarly by dissolving or suspending the active ingredients in a compatible aqueous, aqueous liquid or mixed aqueous organic system including a gelling agent at an appropriate concentration.

In embodiments where the hard surface cleaning compositions are prepared as solid compositions, the solid compositions can include, but are not limited to granular and pelletized solid compositions, powders, solid block compositions, cast solid block compositions, extruded solid block composition, pressed solid compositions, and others.

Solid particulate cleaning compositions can be made by merely blending the dry solid ingredients formed according to the invention in appropriate ratios or agglomerating the materials in appropriate agglomeration systems. Pelletized materials can be manufactured by compressing the solid granular or agglomerated materials in appropriate pelletizing equipment to result in appropriately sized pelletized materials. Solid block and cast solid block materials can be made by introducing into a container either a prehardened block of material or a castable liquid that hardens into a solid block within a container. Preferred containers include disposable plastic containers or water-soluble film containers. Other suitable packaging for the composition includes flexible bags, packets, shrink wrap, and water-soluble film such as polyvinyl alcohol.

The solid cleaning compositions may be formed using a batch or continuous mixing system. In an exemplary embodiment, a single- or twin-screw extruder is used to combine and mix one or more components at high shear to form a homogeneous mixture. In some embodiments, the processing temperature is at or below the melting temperature of the components. The processed mixture may be dispensed from the mixer by forming, casting or other suitable means, whereupon the cleaning composition hardens to a solid form. The structure of the matrix may be characterized according to its hardness, melting point, material distribution, crystal structure, and other like properties according to known methods in the art. Generally, a solid cleaning composition processed according to the method of the invention is substantially homogeneous with regard to the distribution of ingredients throughout its mass and is dimensionally stable.

In an extrusion process, the liquid and solid components are introduced into final mixing system and are continuously mixed until the components form a substantially homogeneous semi-solid mixture in which the components are distributed throughout its mass. The mixture is then discharged from the mixing system into, or through, a die or other shaping means. The product is then packaged. In an exemplary embodiment, the formed composition begins to harden to a solid form in between approximately 1 minute and approximately 3 hours. Particularly, the formed composition begins to harden to a solid form in between approximately 1 minute and approximately 2 hours. More particularly, the formed composition begins to harden to a solid form in between approximately 1 minute and approximately 20 minutes.

In a casting process, the liquid and solid components are introduced into the final mixing system and are continuously mixed until the components form a substantially homogeneous liquid mixture in which the components are distributed throughout its mass. In an exemplary embodiment, the components are mixed in the mixing system for at least approximately 60 seconds. Once the mixing is complete, the product is transferred to a packaging container where solidification takes place. In an exemplary embodiment, the cast composition begins to harden to a solid form in between approximately 1 minute and approximately 3 hours. Particularly, the cast composition begins to harden to a solid form in between approximately 1 minute and approximately 2 hours. More particularly, the cast composition begins to harden to a solid form in between approximately 1 minute and approximately 20 minutes.

In a pressed solid process, a flowable solid, such as granular solids or other particle solids are combined under pressure. In a pressed solid process, flowable solids of the compositions are placed into a form (e.g., a mold or container). The method can include gently pressing the flowable solid in the form to produce the solid cleaning composition. Pressure may be applied by a block machine or a turntable press, or the like. Pressure may be applied at about 1 to about 3000 psi, about 5 to about 2500 psi, or about 10 psi to about 2000 psi. As used herein, the term “psi” or “pounds per square inch” refers to the actual pressure applied to the flowable solid being pressed and does not refer to the gauge or hydraulic pressure measured at a point in the apparatus doing the pressing. The method can include a curing step to produce the solid cleaning composition. As referred to herein, an uncured composition including the flowable solid is compressed to provide sufficient surface contact between particles making up the flowable solid that the uncured composition will solidify into a stable solid cleaning composition. A sufficient quantity of particles (e.g. granules) in contact with one another provides binding of particles to one another effective for making a stable solid composition. Inclusion of an optional curing step may include allowing the pressed solid to solidify for a period of time, such as a few hours, or about 1 day (or longer). In additional aspects, the methods could include vibrating the flowable solid in the form or mold, such as the methods disclosed in U.S. Pat. No. 8,889,048, which is herein incorporated by reference in its entirety.

The use of pressed solids provide numerous benefits over conventional solid block or tablet compositions requiring high pressure in a tablet press, or casting requiring the melting of a composition consuming significant amounts of energy, and/or by extrusion requiring expensive equipment and advanced technical know-how. Pressed solids overcome such various limitations of other solid formulations for which there is a need for making solid cleaning compositions. Moreover, pressed solid compositions retain its shape under conditions in which the composition may be stored or handled.

By the term “solid”, it is meant that the hardened composition will not flow and will substantially retain its shape under moderate stress or pressure or mere gravity. A solid may be in various forms such as a powder, a flake, a granule, a pellet, a tablet, a lozenge, a puck, a briquette, a brick, a solid block, a unit dose, or another solid form known to those of skill in the art. The degree of hardness of the solid cast composition and/or a pressed solid composition may range from that of a fused solid product which is relatively dense and hard, for example, like concrete, to a consistency characterized as being a hardened paste. In addition, the term “solid” refers to the state of the cleaning composition under the expected conditions of storage and use of the solid cleaning composition. In general, it is expected that the cleaning composition will remain in solid form when exposed to temperatures of up to approximately 100° F. and particularly up to approximately 120° F.

The resulting solid cleaning composition may take forms including, but not limited to: a cast solid product; an extruded, molded or formed solid pellet, block, tablet, powder, granule, flake; pressed solid; or the formed solid can thereafter be ground or formed into a powder, granule, or flake. In an exemplary embodiment, extruded pellet materials formed by the solidification matrix have a weight of between approximately 50 grams and approximately 250 grams, extruded solids formed by the composition have a weight of approximately 100 grams or greater, and solid block detergents formed by the composition have a mass of between approximately 1 and approximately 10 kilograms. The solid compositions provide for a stabilized source of functional materials. In some embodiments, the solid composition may be dissolved, for example, in an aqueous or other medium, to create a concentrated and/or use solution. The solution may be directed to a storage reservoir for later use and/or dilution, or may be applied directly to a point of use.

The following patents disclose various combinations of solidification, binding and/or hardening agents that can be utilized in the solid cleaning compositions of the present invention. The following U.S. patents are incorporated herein by reference: U.S. Pat. Nos. 7,153,820; 7,094,746; 7,087,569; 7,037,886; 6,831,054; 6,730,653; 6,660,707; 6,653,266; 6,583,094; 6,410,495; 6,258,765; 6,177,392; 6,156,715; 5,858,299; 5,316,688; 5,234,615; 5,198,198; 5,078,301; 4,595,520; 4,680,134; RE32,763; and RE32818.

Methods of Using the Hard Surface Cleaning Compositions

While an understanding of the mechanism is not necessary to practice the hard surface cleaning compositions described herein, and while the present embodiments are not limited to any particular mechanism of action, it is contemplated that, in some embodiments, the hard surface cleaning compositions can be applied to a surface. In a preferred embodiment, the surface is rinsed after application of the cleaning composition to the surface. Preferably, the hard surface cleaning composition is in contact with the surface for any amount of time sufficient to remove soils from the surface. In some embodiments, the contact time is between about 30 seconds and 10 minutes, more preferably between about 1 minute and about 5 minutes.

The hard surface cleaning compositions can be applied to a surface in any desired manner suitable for the particular surface. For example, the hard surface cleaning compositions can be applied by pouring, spraying, wiping, and/or mopping. Other mechanisms of applying the hard surface cleaning compositions can be performed. In a preferred embodiment, the hard surface cleaning compositions can be dispensed from a dispenser into a container (e.g., a bottle or bucket), a cleaning substrate (e.g., a wipe, a mop, a sponge, and/or a rag) or dispensed directly to a surface for cleaning. Suitable dispensers can contain a concentrated composition or an RTU composition. In a preferred embodiment, a dispenser can both dilute a concentrated cleaning composition and dispense it as an RTU composition.

Preferably, the hard surface cleaning compositions can be applied to any suitable hard surface as defined herein. Preferred hard surfaces, include, but are not limited to floors, rails, counters, walls, chairs, stools, benches, doors, handles, doorknobs, and the like. In a preferred aspect of the invention, the hard surface cleaning compositions are suitable for cleaning a variety of surface materials, including, but not limited to, luxury vinyl tile, linoleum, tile, wood, stone, concrete, grout, laminate, porcelain, plastic, composite, and metal.

In a preferred aspect of the invention, the hard surface cleaning compositions remove a variety of soils, including, but not limited to food soils, cooking soils, and inorganic soils. More preferably, the hard surface cleaning compositions can remove inorganic soils such as a non-polar oily substance which may or may not contain particulate matter such as mineral clays, sand, natural mineral matter, carbon black, graphite, kaolin, environmental dust, dirt, etc., and food soil including proteinaceous soils, starchy soils, polysaccharides, fatty soils including saturated and unsaturated fatty soils, food particulate and matter, etc.

In a preferred embodiment, the hard surface cleaning compositions can remove at least about 50% of the soil on a surface, more preferably at least about 60% of the soil on a surface, still more preferably at least about 70% of the soil on a surface, even more preferably at least about 80% of the soil on a surface, still more preferably at least about 85% of the soil on a surface, even more preferably at least about 90% of the soil on a surface, still more preferably at least about 95% of the soil on a surface, even more preferably at least about 99% of the soil on a surface, and most preferably 100% of the soil on a surface.

All publications and patent applications in this specification are indicative of the level of ordinary skill in the art to which this invention pertains. All publications and patent applications are herein incorporated by reference to the same extent as if each individual publication or patent application was specifically and individually indicated as incorporated by reference.

### EXAMPLE EMBODIMENTS

The inventions are defined in the claims. However, below is provided a non-exhaustive list of non-limiting embodiments listed by paragraph number. Any one or more of the features of these embodiments may be combined with any one or more features of another example, embodiment, or aspect described herein.
1. An enzymatic hard surface cleaning composition comprising:
   a surfactant blend comprising one or more of an anionic surfactant, an amphoteric surfactant, and a nonionic surfactant; wherein the anionic surfactant is sulfated, sulfonated, and/or carboxylated; wherein the amphoteric surfactant comprises an amine oxide, a betaine, a sultaine, or a mixture thereof; wherein the nonionic surfactant comprises an alkyl polyglycoside, a linear or branched alkoxylate, and/or an EO/PO copolymer;
   an enzyme; and
   water; and
   wherein the composition has a pH between about 5.5 and about 10.
2. The composition of paragraph 1, wherein the amphoteric surfactant is a linear or branched, alkoxylated or unalkoxylated C8-C18 amine oxide, amide betaine, or a mixture thereof.
3. The composition of paragraph 1 or 2, wherein the surfactant blend, wherein the nonionic surfactant is an alkyl polyglycoside, a C8-C18 linear or branched, alkyl alkoxylated surfactant, or a mixture thereof.
4. The composition of any one of paragraphs 1-3, wherein the composition further comprises a biocide.
5. The composition of paragraph 4, wherein the biocide comprises a di-alkyl chain quaternary ammonium compound or salt thereof having an R group from about 2 carbons to about 12 carbons, wherein the salt is a bicarbonate, carboxylate, chloride, carbonate, phosphate, sulfonate, sulfate, polycarboxylate, or a combination thereof.
6. The composition of any one of paragraphs 1-3, wherein the surfactant blend comprises an anionic surfactant and an amphoteric surfactant.
7. The composition of any one of paragraphs 1-5, wherein the composition is a concentrated composition having between about 0.01 wt. % and about 15 wt. % of the nonionic surfactant, between about 1 wt. % and about 30 wt. % of the amphoteric surfactant, between about 0.02 wt. % and about 10 wt. % of the biocide, and between about 0.1 wt. % and about 30 wt. % of the enzyme, or mixture thereof.
8. The composition of any one of paragraphs 1, 2 or 6, wherein the anionic surfactant comprises a linear or branched C8-22 alkyl benzene sulfonate, an alpha olefin sulfonate, a C8-C18 linear or branched alkyl sulfate, an alkyl ether sulfate, or a mixture thereof.
9. The composition of any one of paragraphs 1, 2, 6, or 8, wherein the composition is a concentrated composition having between about 1 wt. % and about 30 wt. % of the anionic surfactant, between about 1 wt. % and about 30 wt. % of the amphoteric surfactant, and between about 0.1 wt. % and about 30 wt. % of the enzyme.
10. The composition of any one of paragraphs 1-5, wherein the composition is a ready-to-use cleaning composition having between about 1 ppm and about 10,000 ppm of the nonionic surfactant, between about 25 ppm and about 10,000 ppm of the amphoteric surfactant, and between about 25 ppm and about 25,000 ppm of the enzyme.
11. The composition of any one of paragraphs 1, 2, 6, or 8, wherein the composition is a ready-to-use cleaning composition having between about 25 ppm and about 10,000 ppm of the anionic surfactant, between about 25 ppm and about 10,000 ppm of the amphoteric surfactant, and between about 25 ppm and about 25,000 ppm of the enzyme.
12. A hard surface enzymatic sanitizing composition comprising: a nonionic surfactant; wherein the nonionic surfactnat comprises an alkyl polyglycoside, a linear or branched alkoxylate, an EO/PO copolymer, or a mixture thereof; wherein the composition is free of an anionic surfactant;
   a biocide;
   an enzyme;
   water; and
   wherein the composition has a pH between about 6.5 and about 10.5.
13. The composition of paragraph 12, wherein the surfactant blend, wherein the nonionic surfactant is an alkyl polyglycoside, a C8-C18 linear or branched, alkyl alkoxylated surfactant, or a mixture thereof.
14. The composition of paragraph 12 or paragraph 13, wherein the biocide comprises a di-alkyl chain quaternary ammonium compound or salt thereof having an R group from about 2 carbons to about 12 carbons, wherein the salt is a bicarbonate, carboxylate, chloride, carbonate, phosphate, sulfonate, sulfate, polycarboxylate, or a combination thereof.
15. The composition of any one of paragraphs 12-14, wherein the nonionic surfactant comprises an alkyl polyglycoside and a linear or branched alkoxylate.
16. The composition of any one of paragraphs 12-15, wherein the composition is a concentrated composition having between about 0.01 wt. % and about 15 wt. % of the nonionic surfactant, between about 0.02 wt. % and about 10 wt. % of the biocide, and between about 0.1 wt. % and about 30 wt. % of the enzyme.
17. The composition of any one of paragraphs 12-15, wherein the composition is an RTU composition having between about 5 ppm and about 25,000 ppm of the nonionic surfactant, between about 1 ppm and about 10,000 ppm of the biocide, and between about 5 ppm and about 25,000 ppm of the enzyme.
18. The composition of any one of paragraphs 1-17, wherein the composition further comprises a dye, a sequester, a fragrance, an oxidizer, a pH modifier, a solvent, a water conditioning agent, or a mixture thereof.
19. The composition of any one of paragraphs 1-18, wherein the composition has a pH between about 7 and about 10.
20. The composition of paragraph 18, wherein the composition is a concentrated composition further comprising the water conditioning agent in a concentration between about 0.01 wt. % and about 10 wt. %.
21. The composition of paragraph 18, wherein the composition comprises a ready-to-use cleaning composition having between about 0.1 ppm and about 500 ppm of the water conditioning agent.
22. The composition of any one of paragraphs 1-21, wherein the composition has a surface tension of less than about 28 dynes.
23. The composition of any one of paragraphs 1-22, wherein the enzyme is a protease, amylase, cellulase, lipase, cutinase, peroxidase, gluconase, or a mixture thereof.
24. A method of cleaning a hard surface comprising:
   contacting the hard surface with the composition of any one of paragraphs 1-23; wherein the surface comprises a soil; wherein at least 50% of the soil is removed from the surface; and wherein the composition has a surface contact angle of less than about 50° on the surface.
25. The method of paragraph 24, further comprising rinsing the hard surface.
26. The method of paragraph 24, wherein the composition is left to dry on the hard surface.
27. The method of any one of paragraphs 24-26, wherein the contacting is performed by spraying, wiping, pouring, and/or mopping the hard surface with the hard surface cleaning composition.
28. The method of any one of paragraphs 24-27, wherein the hard surface comprises one or more of the following a drain, a shower, a sink, a toilet, a bathtub, a countertop, a window, a mirror, and a floor.
29. A method of sanitizing a hard surface comprising:
   contacting the hard surface with the composition of any one of paragraphs 1-5, 7, 10, or 12-23; wherein the hard surface comprises a microbial population; and wherein the composition has a surface contact angle of less than about 50° on the surface.
30. The method of paragraph 29, further comprising rinsing the hard surface.
31. The method of any one of paragraphs 29-30, wherein the contacting is performed by spraying, wiping, pouring, and/or mopping the hard surface with the hard surface cleaning composition.
32. The method of any one of paragraphs 29-31, wherein the hard surface comprises one or more of the following a drain, a shower, a sink, a toilet, a bathtub, a countertop, a window, a mirror, and a floor.
33. The method of any one of paragraphs 29-32, wherein the composition is left standing on the surface for a time of at least about 5 minutes after the contacting step.
33. The method of any one of paragraphs 29-32, wherein the composition is left standing on the surface for a time of between about 5 minutes and about 2 hours.
34. The method of any one of paragraphs 29-33, wherein the microbial population is reduced by at least about 99.9%.
35. The method of any one of paragraphs 29-34, wherein the hard surface comprises a soil; and wherein at least 50% of the soil is removed from the surface.

### EXAMPLES

Embodiments of the hard surface cleaning compositions with enzymes and methods of using the same are further defined in the following non-limiting Examples. It should be understood that these Examples, while indicating one or more preferred embodiments, are given by way of illustration only and are non-limiting. From the above discussion and these Examples, one skilled in the art can ascertain the essential characteristics of the invention(s), and without departing from the spirit and scope thereof, can make various changes and modifications of the embodiments of the invention to adapt it to various usages and conditions. Thus, various modifications of the embodiments, in addition to those shown and described herein, will be apparent to those skilled in the art from the foregoing description.

Such modifications are also intended to fall within the scope of the appended claims. Materials used:

Ammonyx® LO: A lauramine oxide, available from Stepan.

Amplify® Prime: An amylase available from Novozymes.

Barlox® 12 (B12): A cocoamine oxide surfactant, available from Lonza.

Bioterge® AS-40K: A sodium C14-16 olefin sulfonate surfactant, available from Stepan.

Carboquat H: A biocidal active comprising a di-alkyl chain quaternary ammonium compound commercially available from Lonza.

Diversey Suma Bio: Suma® Bio-Floor® Cleaner, available from Diversey Global.

Esperase®: A protease available from Novozymes.

Liquanse®: A protease available from Novozymes.

Progress® Uno 100L: A protease, available from Novozymes.

Tomadol® 91-6: An ethoxylated alcohol surfactant, available from Evonik.

Commercially available alkyl olefin sulfonate (AOS), linear alkylbenzene sulfonate (LAS), propylene glycol, glycerin, sorbitol, gelatin, triethanolamine (TEA), monoethanolamine (MEA), sodium laureth sulfate (SLES), protease, amylase, and lipase.

### Example 1

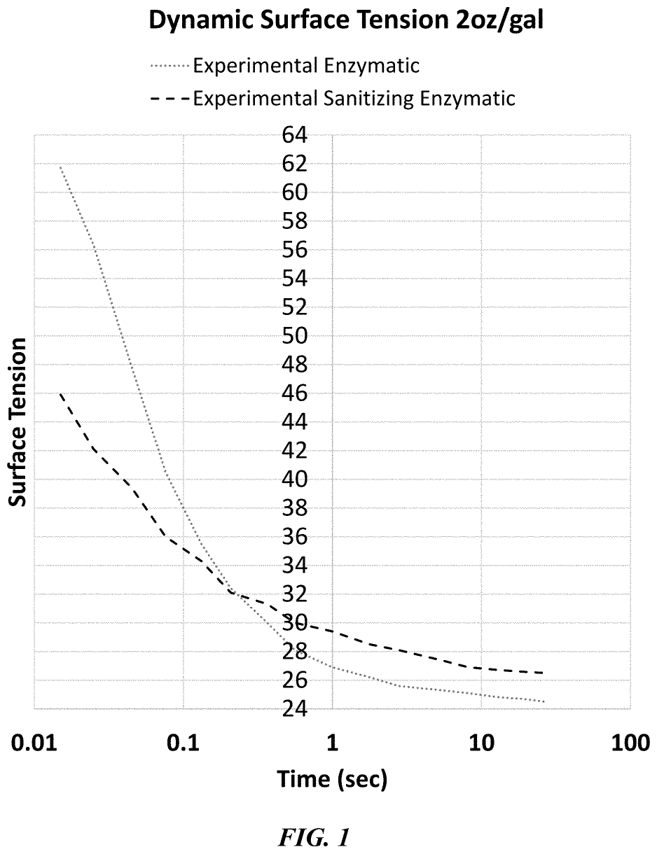

The surface tension of various alkali and enzyme containing surface cleaners was tested. Measurement of surfactant kinetics to the liquid-air interface was conducted. This study was done at room temperature with various commercial hard surface floor cleaners having different surfactant profiles. The results of the alkali cleaners are shown in FIG. 1A. The results of the enzymatic surface cleaners are shown in FIG. 1B.

As shown in the results of FIG. 1A, the alkaline surface cleaners achieve a surface tension of around 25-30 nM/m by 10 seconds. As can be seen in FIG. 1B, this same low surface tension was also obtained by surface cleaners containing enzymes. This shows that the inclusion of an enzyme does not impair the efficacy of the various surfactant systems ability to reduce surface tension.

### Example 2

A food soil composition was prepared from lard and corn oil in a 1:1 ratio with Sudan dye (for color) (referred to as “red soil composition” throughout the Examples). The red soil composition mimics semi-solid fatty soils found on surfaces such as in back of house (BOH) work areas.

An industrial hydrocarbon-based oily soil was prepared from motor oil and diacylglycerol oil in a 9:1 ratio (referred to as “black soil composition” throughout the Examples). The black soil composition mimics soils and oils found on surfaces such as at front of house (FOH) work areas.

Vinyl tile substrates soiled with red soil composition were prepared, and tiles soiled with black soil composition were prepared. The tiles were soiled with approximately 0.15 grams of either the red soil composition or black soil composition. The tiles were soaked in use solutions of various cleaner compositions diluted with water having a water hardness of 5 gpg (grains per gallon). The tiles with red soil were soaked with the various cleaning compositions for 24 hours at room temperature. The tiles with black soil were soaked with the various cleaning compositions for 30 minutes at room temperature.

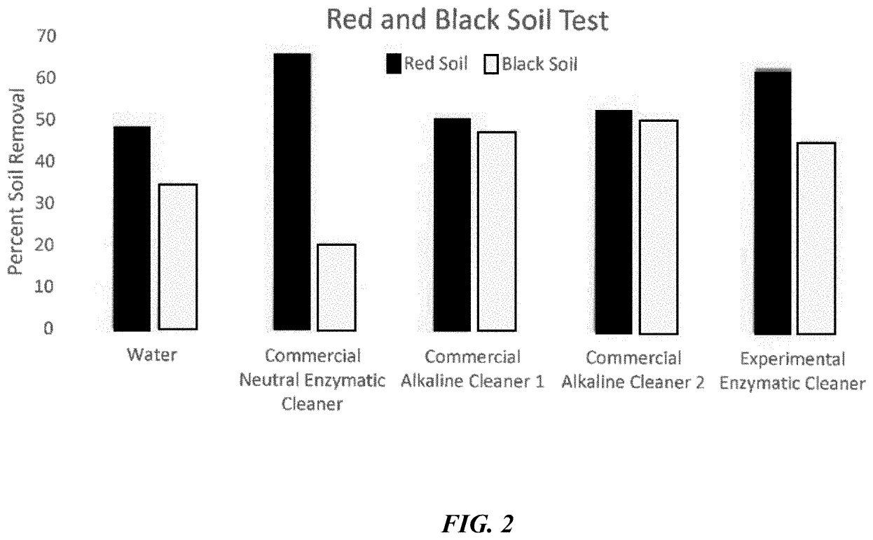

As shown in FIG. 2, the experimental enzymatic cleaner, having a surfactant mix of an alkyl oelfin sulfate, an amine oxide, and an ethoxylated alcohol surfactant, performed better than the commercial cleaners on red soil while performing surprisingly better than the commercial neutral enzymatic cleaner on the clack soil, performing as well as the commercial alkaline cleaners. Further, unlike the commercial natural enzymatic cleaner, the experimental enzymatic cleaner outperformed water on both red and black soils.

### Example 3

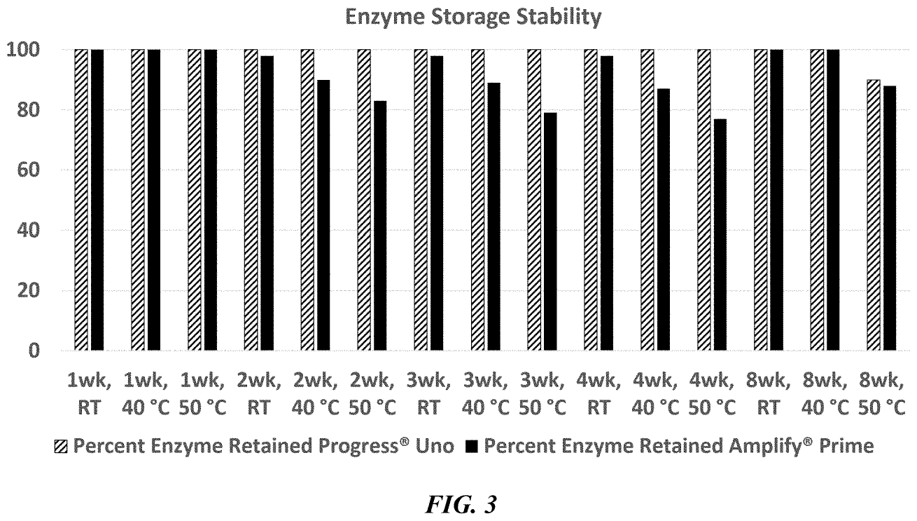

Enzyme stability was also tested for up to 8 weeks under elevated temperature conditions. Progress® Uno and Amplify® Prime were tested as an example protease and amylase, respectively. Two experimental enzymatic cleaners were made—one with Progress® Uno and the other with Amplify® Prime—three samples of each were extracted and then stored at room temperature, 40° C., and 50° C. for eight weeks, with the activity of the enzymes measured on day 0, after one weeks, two weeks, four weeks, and eight weeks. The results are provided in Table 3 and FIG. 3.

TABLE 3

| Storage Temperature | Percent Enzyme Retained | |
|---|---|---|
| and Time | Progress ® Uno | Amplify ® Prime |
| 1wk, RT | 100 | 100 |
| 1wk, 40° C. | 100 | 100 |
| 1wk, 50° C. | 100 | 100 |
| 2wk, RT | 100 | 98 |
| 2wk, 40° C. | 100 | 90 |
| 2wk, 50° C. | 100 | 83 |
| 3wk, RT | 100 | 98 |
| 3wk, 40° C. | 100 | 89 |
| 3wk, 50° C. | 100 | 79 |
| 4wk, RT | 100 | 98 |
| 4wk, 40° C. | 100 | 87 |
| 4wk, 50° C. | 100 | 77 |
| 8wk, RT | 100 | 100 |
| 8wk, 40° C. | 100 | 100 |
| 8wk, 50° C. | 90 | 88 |

While the amylase did not have the same storage stability as the protease, it still exemplified high storage stability under strenuous temperature conditions. Further, the protease exhibited excellent stability only showing a decrease after 8 weeks at 50° C. The strenuous temperature conditions are offered to demonstrate how the compositions would store over long periods of time. Typically, the compositions are not stored at elevated conditions, but by increasing the temperature, the stress on the compositions are increased similar to how they would be over a lengthy period of time, e.g., 9 months, 1 year, or longer. As can be seen, in Table 3 and FIG. 3, the experimental enzymatic cleaners display long term storage capability at elevated storage temperatures.

### Example 4

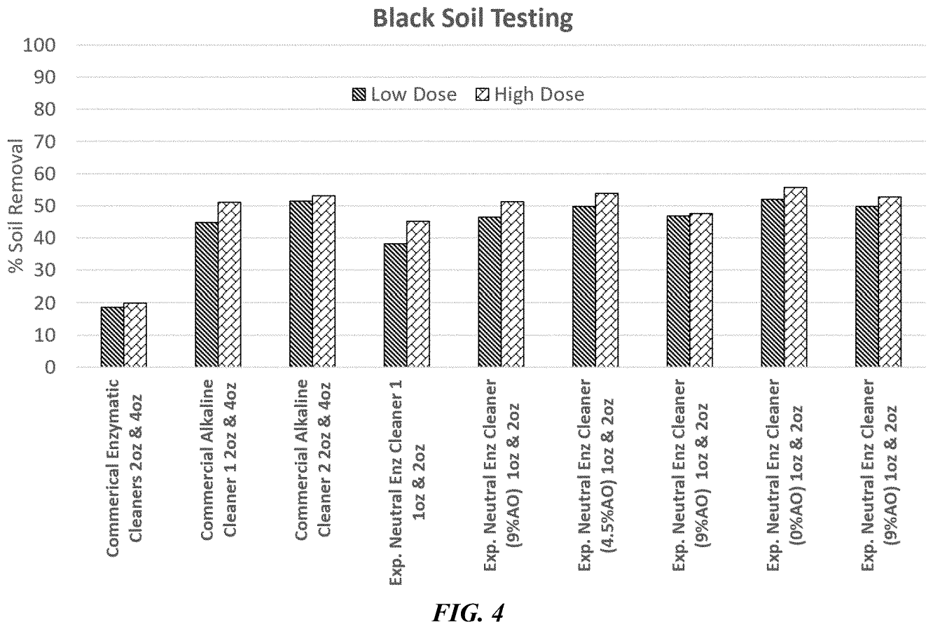

Various experimental enzymatic cleaners at neutral pH and with different amounts of amine oxide (AO) were tested and compared to commercial enzymatic and alkaline cleaners on black soil at various concentrations using the method as described above. Results can be seen in FIG. 4 and summarized in Table 4.

As can be seen in FIG. 4 and Table 4, the Experimental Neutral Enzymatic Cleaner significantly outperformed the commercial enzymatic cleaners at both concentrations. Further, the low AO containing (0 or 4.5% AO) Experimental Neutral Enzymatic Cleaners had similar performance to both Commercial Alkaline Cleaners at the same concentrations. However, as the amount of AO is increased, the Experimental Neutral Enzymatic Cleaners, while still performing significantly better than commercially available enzymatic cleaners, did not perform as well as the Commercial Alkaline Cleaners. These results demonstrate that the concentration of the AO may have an impact on black soil removal, with increased black soil removal at lower concentrations of AO.

TABLE 4
Summary of Black Soil Cleaner Data

| | % soil | % soil |
|---|---|---|
| | removal | removal |
| Product Description | (low dose) | (high dose) |
| Commercial Enzymatic Cleaners 2 oz & 4 oz | 18.566 | 19.898 |
| Commercial Alkaline Cleaner 1 2 oz & 4 oz | 44.724 | 51.071 |
| Commercial Alkaline Cleaner 2 2 oz & 4 oz | 51.444 | 53.007 |
| Exp. Neutral Enz Cleaner 1 1 oz & 2 oz | 38.115 | 45.176 |
| Exp. Neutral Enz Cleaner (9% AO) 1 oz & 2 oz | 46.366 | 51.285 |
| Exp. Neutral Enz Cleaner (4.5% AO) 1 oz & 2 oz | 49.699 | 53.745 |
| Exp. Neutral Enz Cleaner (9% AO) 1 oz & 2 oz | 46.842 | 47.556 |
| Exp. Neutral Enz Cleaner (0% AO) 1 oz & 2 oz | 52.079 | 55.649 |
| Exp. Neutral Enz Cleaner (9% AO) 1 oz & 2 oz | 49.778 | 52.713 |

### Example 5

The ability to remove greasy and proteinaceous soil by soaking was tested. The Experimental Enzymatic Cleaner was compared to various Commercial neutral Enzymatic Cleaner and various Commercial Alkaline Cleaner on a soil mixture of 2:1 lard:vegetable oil with 0, 5%, or 25% egg protein. Tiles were coated with the soil and allowed to soak for 3 or 20 hours. After the soak, the amount of soil removed was calculated.

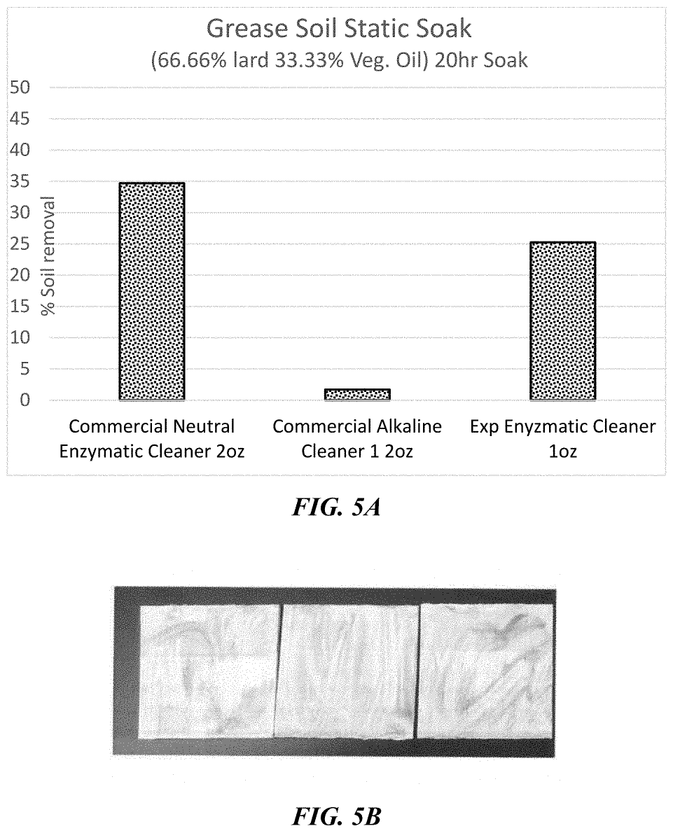

FIGS. 5A and 5B show the results of a 20-hour soak with 0% protein in a greasy soil. As can be seen in FIG. 5A, both enzymatic cleaners greatly outperformed the Commercial Alkaline Cleaner, with the Commercial Alkaline Cleaner not capable of removing 5% of the soil from the tile. However, both enzymatic cleaners were capable of removing between 30-35% of the soil just through soaking.

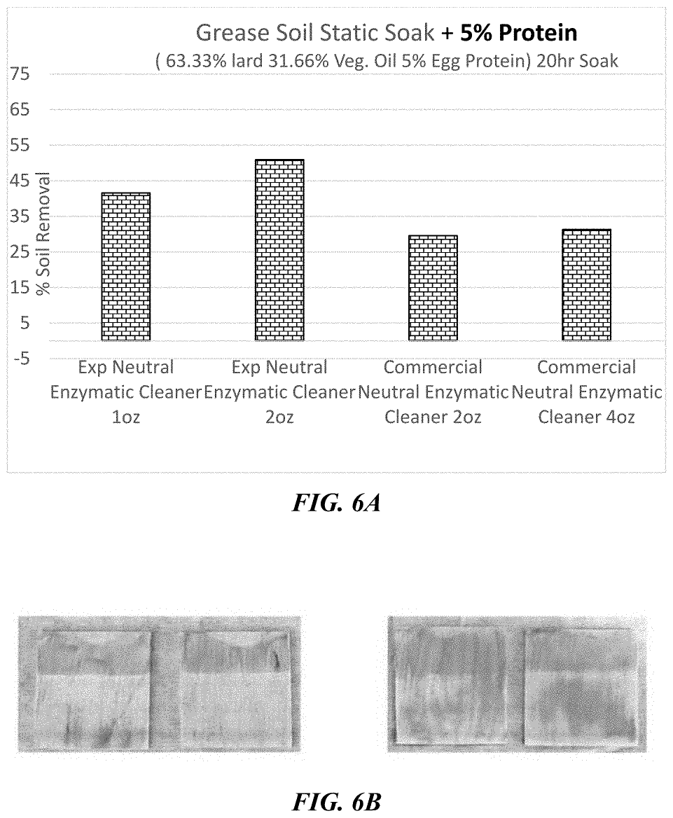

FIGS. 6A and 6B show the results of a 20-hour soak with 5% protein in a greasy soil at a low and high dose of the Exp Neutral Enzymatic Cleaner and Commercial Neutral Enzymatic Cleaner. As shown in FIG. 6A, and similar to the purely greasy soil (0%, above), the commercial cleaner at both dosages was able to remove up to about 35% of the soil from the tile. However, even the low dosage of the Exp Neutral Enzymatic Cleaner was more efficacious in removing the soil than the high dosage of the commercial cleaner, removing up to 55% of the low proteinaceous greasy soil.

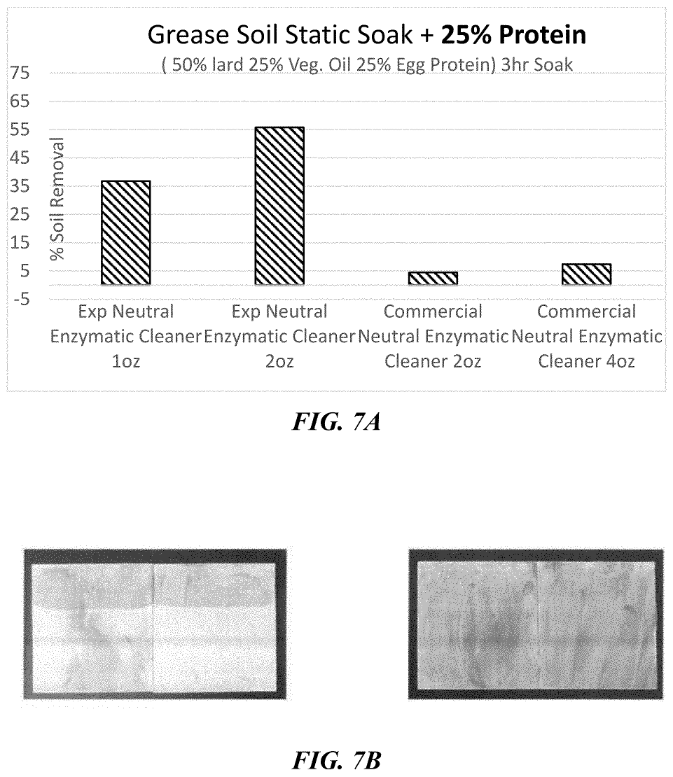

FIGS. 7A and 7B show the results of a 3-hour soak with 25% protein in a greasy soil at a low and high dose of the Exp Neutral Enzymatic Cleaner and Commercial Neutral Enzymatic Cleaner. As shown in FIG. 7A, the performance of the commercial cleaner drastically decreases at the elevated amount of protein while the Exp Neutral Enzymatic Cleaner maintains or improves performance, being able to remove up to 55% of the soil at the higher concentration.

These results show that the Commercial Alkaline Cleaner (FIGS. 5A and 5B) is ineffective at removing greasy soil, while the Commercial Neutral Enzymatic Cleaner is increasingly ineffective at removing soil as the amount of protein increases when compared to the Exp Neutral Enzymatic Cleaner. Further, these results show that at higher concentrations of the Exp Neutral Enzymatic Cleaner, soil removal improves as protein concentration in the soil increases.

### Example 6

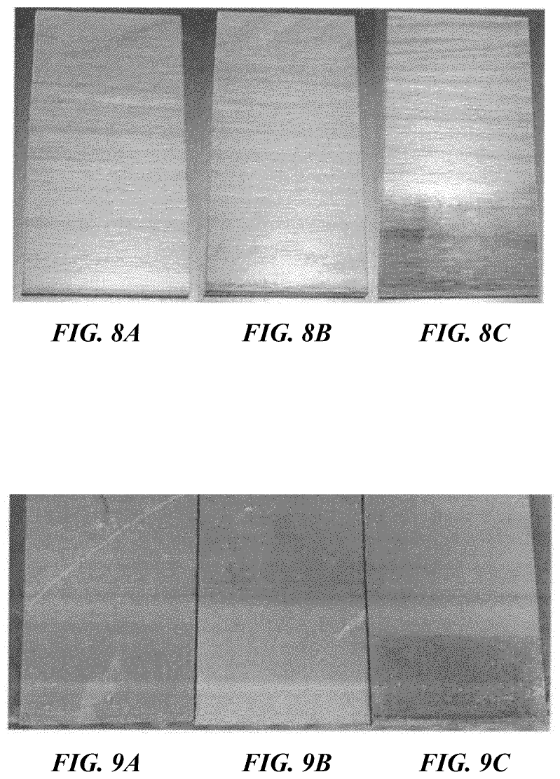

The amount of residual chemicals left behind on surfaces was also tested at different levels of hard water. To simulate two years of repeated washings, tiles were dipped 730 times into solutions of the experimental enzymatic cleaner made with 0 gpg, 5 gpg, or 17 gpg water to simulate different levels of hard water. As shown in FIGS. 8A-8C, there was only chemical build up in the 17 gpg water solutions.

To determine if the chemical residue buildup may be compensated for, solutions of the experimental enzymatic cleaner made with 17 gpg water and triethylamine (TEA) with at different pH and with or without citrate. As shown in FIGS. 9A-9C, even at a higher pH level, the inclusion of citrate prevented a chemical residue buildup on the tiles after 100 dips.

These results show that the experimental enzymatic cleaners will not leave residue behind in soft water and only need an optional sequestrant in hard water.

### Example 7

To further determine the stability of various enzymes within the experimental compositions, various embodiments with different enzymes as presented in Tables 5-7 were tested at different temperatures for 8 weeks. The results are summarized in Table 8.

As shown in Table 8, the stability of the enzymes differed depending on the temperature and the solvent. Across all temperatures and solvents, Progress Uno 100L performed best on average, and outperforming both Liquanse and Esperase at temperatures above room temperature. However, both Liquanse and Esperase had higher stability at room temperature in propylene glycol than Progress Uno 100L. Esperase also has better eight-week stability in glycerin than Progress Uno 100L at room temperature.

TABLE 5

| | Ex. 1 | Ex. 2 | Ex. 3 | Ex. 4 | Ex. 5 | Ex. 6 |
|---|---|---|---|---|---|---|
| Component | (wt. %) | | | | | |
| Water | 34 | 34 | 34 | 34 | 34 | 34 |
| Bioterge AS-40K | 20 | 20 | 20 | 20 | 20 | 20 |
| Tomadol 91-6 | 7 | 7 | 7 | 7 | 7 | 7 |
| Ammonyx LO | 18 | 18 | 18 | 18 | 18 | 18 |
| Propylene Gylcol | 15 | 15 | 15 | | | |
| Glycerin | — | — | — | 15 | 15 | 15 |
| Triethanolamine | 5 | 5 | 5 | 5 | 5 | 5 |
| Progress Uno | 1 | — | — | 1 | — | — |
| Liquinase | — | 1 | — | — | 1 | — |
| Esperase | — | — | 1 | — | — | 1 |

TABLE 6

| | Ex. 7 | Ex. 8 | Ex. 9 | Ex. 10 | Ex. 11 | Ex. 12 |
|---|---|---|---|---|---|---|
| Component | (wt. %) | | | | | |
| Water | 34 | 34 | 34 | 34 | 34 | 34 |
| Bioterge AS-40K | 20 | 20 | 20 | 20 | 20 | 20 |
| Tomadol 91-6 | 7 | 7 | 7 | 7 | 7 | 7 |
| Ammonyx LO | 18 | 18 | 18 | 18 | 18 | 18 |
| Sorbitol | 15 | 15 | 15 | 7.5 | 7.5 | 7.5 |
| Glycerin | — | — | — | 7.5 | 7.5 | 7.5 |
| Triethanolamine | 5 | 5 | 5 | 5 | 5 | 5 |
| Progress Uno | 1 | — | — | 1 | — | — |
| Liquinase | — | 1 | — | — | 1 | — |
| Esperase | — | — | 1 | — | — | 1 |

TABLE 7

| | Ex. 13 | Ex. 14 | Ex. 15 |
|---|---|---|---|
| Component | (wt. %) | | |
| Water | 48 | 48 | 48 |
| Bioterge AS-40K | 20 | 20 | 20 |
| Tornadol 91-6 | 7 | 7 | 7 |
| Ammonyx LO | 18 | 18 | 18 |
| Gelatin | 1 | 1 | 1 |
| Triethanolamine | 5 | 5 | 5 |
| Progress Uno | 1 | — | — |
| Liquinase | — | 1 | — |
| Esperase | — | — | 1 |

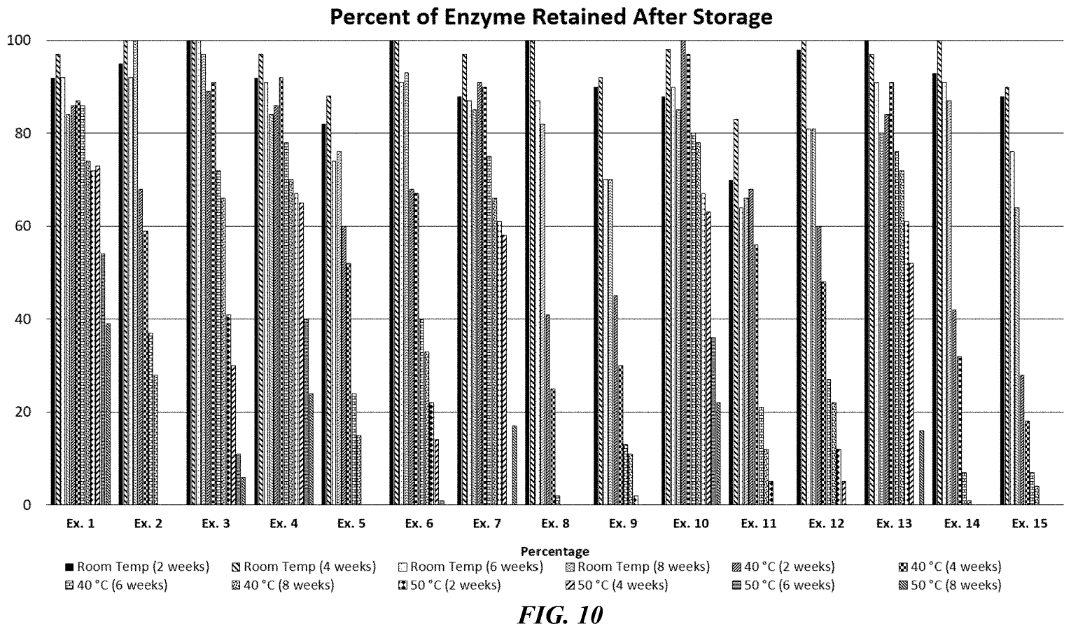

The data from Table 8 is also provided in a bar graph comparison in FIG. 10. These results indicate that depending on the temperature and the solvent, the stability of the enzyme may be preserved, and the solvent and enzyme may be optimized depending on the expected storage conditions.

TABLE 8

| | | Percent Enzyme Retained | | | | | | | |
|---|---|---|---|---|---|---|---|---|---|
| Temp. | Weeks | Ex. 1 | Ex. 2 | Ex. 3 | Ex. 4 | Ex. 5 | Ex. 6 | Ex. 7 | Ex. 8 |
| RT | 2 | 92 | 95 | 100 | 92 | 82 | 100 | 88 | 100 |
| RT | 4 | 97 | 100 | 100 | 97 | 88 | 100 | 97 | 100 |
| RT | 6 | 92 | 92 | 100 | 91 | 74 | 91 | 87 | 87 |
| RT | 8 | 84 | 100 | 97 | 84 | 76 | 93 | 85 | 82 |
| 40° C. | 2 | 86 | 68 | 89 | 86 | 60 | 68 | 91 | 41 |
| 40° C. | 4 | 87 | 59 | 91 | 92 | 52 | 67 | 90 | 25 |
| 40° C. | 6 | 86 | 37 | 72 | 78 | 24 | 40 | 75 | 2 |
| 40° C. | 8 | 74 | 28 | 66 | 70 | 15 | 33 | 66 | 0 |
| 50° C. | 2 | 72 | 0 | 41 | 67 | 0 | 22 | 61 | 0 |
| 50° C. | 4 | 73 | 0 | 30 | 65 | 0 | 14 | 58 | 0 |
| 50° C. | 6 | 54 | 0 | 11 | 40 | 0 | 1 | 0 | 0 |
| 50° C. | 8 | 39 | 0 | 6 | 24 | 0 | 0 | 17 | 0 |
| | | Percent Enzyme Retained | | | | | | | |
| Temp. | Weeks | Ex. 9 | Ex. 10 | Ex. 11 | Ex. 12 | Ex. 13 | Ex. 14 | Ex. 15 | |
| RT | 2 | 90 | 88 | 70 | 98 | 100 | 93 | 88 | |
| RT | 4 | 92 | 98 | 83 | 100 | 97 | 100 | 90 | |
| RT | 6 | 70 | 90 | 64 | 81 | 91 | 91 | 76 | |
| RT | 8 | 70 | 85 | 66 | 81 | 80 | 87 | 64 | |
| 40° C. | 2 | 45 | 100 | 68 | 60 | 84 | 42 | 28 | |
| 40° C. | 4 | 30 | 97 | 56 | 48 | 91 | 32 | 18 | |
| 40° C. | 6 | 13 | 80 | 21 | 27 | 76 | 7 | 7 | |
| 40° C. | 8 | 11 | 78 | 12 | 22 | 72 | 1 | 4 | |
| 50° C. | 2 | 2 | 67 | 5 | 12 | 61 | 0 | 0 | |
| 50° C. | 4 | 0 | 63 | 0 | 5 | 52 | 0 | 0 | |
| 50° C. | 6 | 0 | 36 | 0 | 0 | 0 | 0 | 0 | |
| 50° C. | 8 | 0 | 22 | 0 | 0 | 16 | 0 | 0 | |

(Table 8 is continued on the next page).

### Example 8

The performance at neutral pH was tested on 100% greasy soil (2:1 lard:corn oil; 20 hour soak) and grease (2:1 lard:corn oil) with 25% egg protein (2 hour soak) for various commercial alkaline and enzymatic cleaners (including Diversey Suma Bio: Suma® Bio-Floor® Cleaner) and the experimental enzymatic cleaners. The enzymatic cleaners were further tested against 100% starch and 100% protein. Each cleaner was prepared at a dilution of 2 oz. per gallon of water.

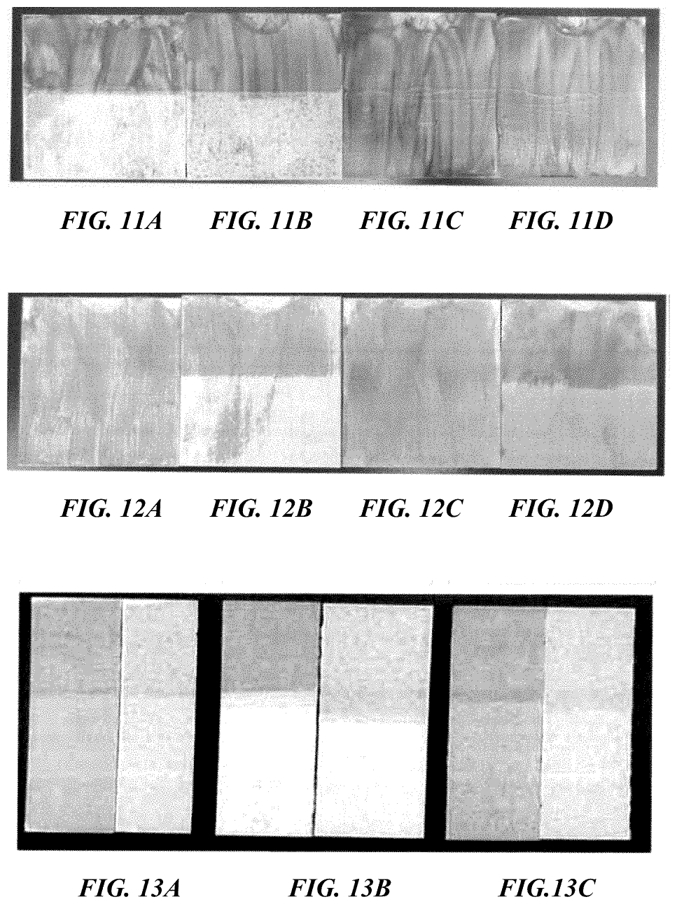

As shown in FIGS. 11A-11D, the commercial alkaline cleaner had the best performance with the experimental enzymatic cleaner performing nearly as well. Both cleaners performed better than the other commercial cleaners for the removal of 100% greasy soil. However, like Example 5, when protein is added to the grease, the commercial alkaline cleaners no longer perform well, whereas the enzymatic cleaners have increased performance. This result can be seen in FIGS. 11A-12D with the experimental enzymatic cleaner having the best performance after a 2 hour soak in the greasy plus proteinaceous soil.

This performance efficacy is also shown in FIGS. 13A-13C. FIGS. 13A-D show a comparison between a commercial alkaline cleaner (FIG. 13A), the experimental enzymatic cleaner (FIG. 13B), and a commercial enzymatic cleaner (FIG. 13C) on 100% starch (left columns; 30 min soak) or 100% protein (right columns 3 hour soak) at neutral pH. As can be seen in FIG. 13, the experimental enzymatic cleaner outperformed both the commercial cleaners for both starch and protein.

These results show that there is synergy between the surfactants and enzymes in the experimental enzymatic cleaner, as neither an alkaline nor an enzymatic cleaner is capable of the same level of performance.

### Example 9

Hard surface cleaning compositions containing a biocide were tested to assess cidal efficacy. The following tests were performed:
ASTM E1054-21 Standard Test Method for Evaluation of Inactivators of Antimicrobial Agents;
ASTM E1153-14 Standard Test Method for Efficacy of Sanitizers Recommended for Inanimate Hard, Nonporous Non-Food Contact Surfaces;
U.S. EPA OCSPP 810.2000: General Considerations for Testing Public Health Antimicrobial Pesticides—Guidance for Efficacy Testing (February 2018); and
U.S. EPA OCSPP 810.2300 Sanitizers for Use on Hard Surfaces—Efficacy Data Recommendations (Sep. 4, 2012).

For non-food sanitization, the hard surface biocidal composition was tested against were S. Aureus (ATCC 6538) and K. Aerogenes (ATCC 13048). Three compositions were prepared per Table 9 below and then diluted with water to a concentration of 1.50% before testing per the guidelines listed above. The compositions were applied to a surface soiled with the bacteria by a mop and the surface contact time prior to rinsing was 5 minutes. The results of non-food sanitizing tests are shown in Table 10 below.

TABLE 9

| | | Non-Sanitizing | |
|---|---|---|---|
| | | Hard Surface | Sanitizing Hard |
| Ingredient | Biocide Control | Cleaner | Surface Cleaner |
| Carboquat H | 100% | 1-6 | 1-6 |
| Nonionic Surfactant | 0 | 10-15 | 10-15 |
| Blend | | | |
| Alkalinity Source | 0 | 1.5-5 | 1.5-5 |
| Solvent | 0 | 10-20 | 10-20 |
| Enzyme | 0 | 0 | 0.3-1.5 |
| Water | 0 | 60-70 | 60-70 |

TABLE 10

| | % Bacteria Reduction | |
|---|---|---|
| Formulation | S. Aureus | K. Aerogenes |
| Biocide Control | 99.999 | 99.9 |
| Non-Sanitizing Hard Surface | 0.79 | 0 |
| Cleaner | | |
| Sanitizing Hard Surface | 99.99 | 99.98 |
| Cleaner | | |

As can be seen from Table 10, the sanitizing hard surface cleaning provided essentially the same reduction in bacteria as the biocide on its own. The composition without the biocide failed to provide any real bacteria reduction. The 0.79% reduction in S. Aureus is attributed to removal via mopping and rinsing as opposed to true cidal activity.

The inventions being thus described, it will be obvious that the same may be varied in many ways. Such variations are not to be regarded as a departure from the spirit and scope of the inventions. Since many embodiments can be made without departing from the spirit and scope of the invention, the invention resides in the claims.

What is claimed is:

1. An enzymatic hard surface cleaning composition comprising:
a surfactant blend comprising one or more of an anionic surfactant, an amphoteric surfactant, and a nonionic surfactant; wherein the anionic surfactant is sulfated, sulfonated, and/or carboxylated; wherein the amphoteric surfactant comprises an amine oxide, a betaine, a sultaine, or a mixture thereof; wherein the nonionic surfactant comprises an alkyl polyglycoside, a linear or branched alkoxylate, and/or an EO/PO copolymer;
an enzyme, wherein the enzyme is a protease, amylase, cellulase, lipase, cutinase, peroxidase, gluconase, or a mixture thereof; and
water; and
wherein the composition has a pH between about 5.5 and about 10.

2. The composition of claim 1, wherein the amphoteric surfactant is a linear or branched, alkoxylated or unalkoxylated C8-C18 amine oxide, amide betaine, or a mixture thereof.

3. The composition of claim 1, wherein the surfactant blend, wherein the nonionic surfactant is an alkyl polyglycoside, a C8-C18 linear or branched, alkyl alkoxylated surfactant, or a mixture thereof.

4. The composition of claim 1, wherein the composition further comprises a biocide;
wherein the biocide comprises a di-alkyl chain quaternary ammonium compound or salt thereof having an R group from about 2 carbons to about 12 carbons, wherein the salt is a bicarbonate, carboxylate, chloride, carbonate, phosphate, sulfonate, sulfate, polycarboxylate, or a combination thereof.

5. The composition of claim 2, wherein the surfactant blend comprises an anionic surfactant and an amphoteric surfactant.

6. The composition of claim 4, wherein the composition is a concentrated composition having between about 0.01 wt. % and about 15 wt. % of the nonionic surfactant, between about 1 wt. % and about 30 wt. % of the amphoteric surfactant, between about 0.02 wt. % and about 10 wt. % of the biocide, and between about 0.1 wt. % and about 30 wt. % of the enzyme, or mixture thereof.

7. The composition of claim 5, wherein the anionic surfactant comprises a linear or branched C8-22 alkyl benzene sulfonate, an alpha olefin sulfonate, a C8-C18 linear or branched alkyl sulfate, an alkyl ether sulfate, or a mixture thereof.

8. The composition of claim 7, wherein the composition is a concentrated composition having between about 1 wt. % and about 30 wt. % of the anionic surfactant, between about 1 wt. % and about 30 wt. % of the amphoteric surfactant, and between about 0.1 wt. % and about 30 wt. % of the enzyme.

9. The composition of claim 1, wherein the composition is a ready-to-use cleaning composition having between about 1 ppm and about 10,000 ppm of the nonionic surfactant, between about 25 ppm and about 10,000 ppm of the amphoteric surfactant, and between about 25 ppm and about 25,000 ppm of the enzyme.

10. The composition of any one of claim 7, wherein the composition is a ready-to-use cleaning composition having between about 25 ppm and about 10,000 ppm of the anionic surfactant, between about 25 ppm and about 10,000 ppm of the amphoteric surfactant, and between about 25 ppm and about 25,000 ppm of the enzyme.

11. A hard surface enzymatic sanitizing composition comprising:
a nonionic surfactant; wherein the nonionic surfactant comprises an alkyl polyglycoside, a linear or branched alkoxylate, an EO/PO copolymer, or a mixture thereof wherein the composition is free of an anionic surfactant;
a biocide; wherein the biocide comprises a di-alkyl chain quaternary ammonium compound or salt thereof having an R group from about 2 carbons to about 12 carbons, wherein the salt is a bicarbonate, carboxylate, chloride, carbonate, phosphate, sulfonate, sulfate, polycarboxylate, or a combination thereof.
an enzyme, wherein the enzyme is a protease, amylase, cellulase, lipase, cutinase, peroxidase, gluconase, or a mixture thereof;
water; and
wherein the composition has a pH between about 6.5 and about 10.5.

12. The composition of claim 11, wherein the nonionic surfactant comprises a mixture of an alkyl polyglycoside and a C8-C18 linear or branched alkyl alkoxylated surfactant.

13. The composition of claim 11, wherein the composition is a concentrated composition having between about 0.01 wt. % and about 15 wt. % of the nonionic surfactant, between about 0.02 wt. % and about 10 wt. % of the biocide, and between about 0.1 wt. % and about 30 wt. % of the enzyme; and wherein the composition has a pH between about 7 and about 10.

14. The composition of claim 11, wherein the composition is an RTU composition having between about 5 ppm and about 25,000 ppm of the nonionic surfactant, between about 1 ppm and about 10,000 ppm of the biocide, and between about 5 ppm and about 25,000 ppm of the enzyme; and wherein the composition has a pH between about 7 and about 10.

15. The composition of claim 11, wherein the composition further comprises a dye, a sequester, a fragrance, an oxidizer, a pH modifier, a solvent, a water conditioning agent, or a mixture thereof.

16. The composition of claim 11, wherein the composition has a surface tension of less than about 28 dynes.

17. A method of sanitizing a hard surface comprising:
contacting the hard surface with the composition of claim 14; wherein the surface comprises a microbial population; wherein the composition has a surface contact angle of less than about 50° on the surface; and
wherein the microbial population is reduced after the contacting step.

18. The method of claim 17, further comprising rinsing the hard surface.

19. The method of claim 17, wherein the contacting is performed by spraying, wiping, pouring, and/or mopping the hard surface with the hard surface cleaning composition.

20. The method of claim 17, wherein the hard surface comprises one or more of the following a drain, a shower, a sink, a toilet, a bathtub, a countertop, a window, a mirror, and a floor.
